(19) United States
(12) Patent Application Publication
(10) Pub. No.: US 2015/0120060 A1
(43) Pub. Date: Apr. 30, 2015

(54) APPARATUS CONTROL METHOD, APPARATUS CONTROL SERVER, NOTIFICATION APPARATUS, ROBOT TERMINAL, APPARATUS CONTROL SYSTEM, AND STORAGE MEDIUM

(71) Applicant: SHARP KABUSHIKI KAISHA, Osaka (JP)

(72) Inventors: Yasunori YAMASHITA, Osaka-shi (JP); Masafumi HIRATA, Osaka-shi (JP); Hideaki KIZUKI, Osaka-shi (JP); Makoto SHINKAI, Osaka-shi (JP)

(73) Assignee: SHARP KABUSHIKI KAISHA, Osaka (JP)

(21) Appl. No.: 14/526,704

(22) Filed: Oct. 29, 2014

(30) Foreign Application Priority Data
Oct. 31, 2013 (JP) 2013-227570

(51) Int. Cl. H04L 29/08; B25J 9/00; G10L 17/22; B25J 11/00

(52) U.S. Cl. CPC H04L 67/02; B25J 11/0085; B25J 9/0003; G10L 17/22; Y10S 901/01
USPC 700/264; 709/217; 704/270.1; 901/1

(57) ABSTRACT

The apparatus control method includes the steps of designating at least one notification apparatus, determining notification information, judging a status of the designated notification apparatus, and transmitting the notification information to the designated notification apparatus in accordance with a judgment result obtained in the status judging step.

This Nonprovisional application claims priority under 35 U.S.C. §119 on Patent Application No. 2013-227570 filed in Japan on Oct. 31, 2013, the entire contents of which is hereby incorporated by reference.

### TECHNICAL FIELD

The present invention relates to an apparatus control method, an apparatus control server, a notification apparatus, a robot terminal, an apparatus control system, and a computer-readable storage medium in which a program is stored.

### BACKGROUND ART

A technique is known which collectively controls a plurality of apparatuses connected with a network.

For example, Patent Literature 1 discloses a technique in which a predetermined number of network apparatuses are selected, as destinations, from among network apparatuses connected with a network, and audio data is simultaneously transmitted to the predetermined number of selected network apparatuses.

### CITATION LIST

### Patent Literature

[Patent Literature 1]
Japanese Patent Application Publication Tokukai No. 2008-187363 (Publication date: Aug. 14, 2008)

### SUMMARY OF INVENTION

### Technical Problem

Meanwhile, in recent years, household electric apparatuses (or electric appliances) which can be connected with a network have been studied actively. In a case where an operation instruction on notifying a user of information is given to a household electric apparatus (or an electric appliance) connected with a network by utilizing the technique disclosed in Patent Literature 1, an exclusive relationship may be caused, in the household electric apparatus, between the notification operation and a process other than the notification operation (i.e., a case may occur where the processes cannot be carried out simultaneously or it is not preferable to carry out the processes simultaneously).

As a result, intended information is not conveyed to an intended user, and this can impair user-friendliness.

The present invention is accomplished in view of the problems, and its object is to provide an apparatus control server, an apparatus control method, a notification apparatus, a robot terminal, an apparatus control system, and a computer-readable storage medium in which a program is stored, each of which does not impair user-friendliness even in a case where an exclusive process is carried out between a notification process and a process other than the notification process which are carried out by the notification apparatus.

### Solution to Problem

In order to attain the object, an apparatus control method in accordance with an aspect of the present invention is a method including the steps of: (a) designating at least one notification apparatus to carry out a notification operation; (b) determining notification information that indicates a content of the notification operation; (c) judging a status of a designated notification apparatus which has been designated in the step (a); and (d) transmitting the notification information to the designated notification apparatus in accordance with a judgment result obtained in the step (c).

In order to attain the object, an apparatus control server in accordance with an aspect of the present invention includes: a notification apparatus designating section configured to designate at least one notification apparatus to carry out a notification operation; a notification information determining section configured to determine notification information that indicates a content of the notification operation; a status judging section configured to judge a status of a designated notification apparatus which has been designated by the notification apparatus designating section; and a transmitting section configured to transmit the notification information to the designated notification apparatus in accordance with a judgment result obtained by the status judging section.

In order to attain the object, a notification apparatus in accordance with an aspect of the present invention receives notification information transmitted from an apparatus control server and carries out a content of a notification operation indicated by the notification information, the notification apparatus including: a notification apparatus status judging section configured to judge whether or not a status of the notification apparatus is busy; and a status transmitting section configured to transmit a notice which indicates that the status of the notification apparatus is busy in a case where the notification apparatus status judging section has determined that the status of the notification apparatus is busy.

In order to attain the object, a robot terminal in accordance with an aspect of the present invention includes: a questioning audio obtaining section configured to obtain an audio given by a user as questioning audio data; an audio data transmitting section configured to transmit the questioning audio data; a notification information receiving section configured to receive notification information that contains an answer character string associated with audio information indicated by the questioning audio data; an audio data generating section configured to generate audio speaking data that represents the answer character string; and an audio data outputting section configured to output the audio speaking data by reproducing the audio speaking data.

In order to attain the object, an apparatus control system in accordance with an aspect of the present invention includes an apparatus control server and a notification apparatus,

the notification apparatus including: a notification apparatus status judging section configured to judge whether or not a status of the notification apparatus is busy; and a transmitting section configured to transmit a notice which indicates that the status of the notification apparatus is busy in a case where the notification apparatus status judging section has determined that the status of the notification apparatus is busy,

the apparatus control server including: a notification apparatus designating section configured to designate at least one notification apparatus to carry out a notification operation; a notification information determining section configured to determine notification information that indicates a content of the notification operation; a status judging section configured to judge whether or not a status of a designated notification apparatus, which has been designated by the notification apparatus designating section, is busy; and a transmitting section configured to transmit the notification information to the designated notification apparatus in a case where the status determined by the status judging section is not busy, upon receipt of a notice which indicates the status of busy and has been transmitted from the notification apparatus, the status judging section determines that the status of the notification apparatus is busy.

### Advantageous Effects of Invention

According to an aspect of the present invention, it is possible to provide an apparatus control server, an apparatus control method, a notification apparatus, a robot terminal, an apparatus control system, and a computer-readable storage medium in which a program is stored, each of which does not impair user-friendliness even in a case where an exclusive process is carried out between a notification process and a process other than the notification process which are carried out by a notification apparatus.

### BRIEF DESCRIPTION OF DRAWINGS

FIG. 1 is a functional block diagram illustrating a configuration of an apparatus control server in accordance with Embodiment 1 of the present invention.

FIG. 2 is a view schematically illustrating, in each of (a) and (b), an apparatus control system including the apparatus control server in accordance with Embodiment 1 of the present invention.

FIG. 3 is a block diagram schematically illustrating a configuration of an apparatus control server in accordance with Embodiment 1 of the present invention.

FIG. 4 is a view illustrating an example of a group managing table for managing groups in the apparatus control server in accordance with Embodiment 1 of the present invention.

FIG. 5 is a view illustrating an example of an apparatus managing table for managing terminals registered in a group in the apparatus control server, in accordance with Embodiment 1 of the present invention.

FIG. 6 is a view illustrating an example of a schedule managing table for managing a speaking schedule in the apparatus control server in accordance with Embodiment 1 of the present invention.

FIG. 7 is a sequence diagram illustrating a flow of processes in the apparatus control system which includes the apparatus control server in accordance with Embodiment 1 of the present invention.

FIG. 8 is a functional block diagram illustrating a configuration of an apparatus control server in accordance with Embodiment 3 of the present invention.

FIG. 9 is a sequence diagram illustrating a flow of processes in an apparatus control system which includes an apparatus control server in accordance with Embodiment 2 of the present invention.

FIG. 10 illustrates an example of recognition phrases and answer phrases in the apparatus control server in accordance with Embodiment 3 of the present invention.

FIG. 11 illustrates an example of ambiguous phrases in the apparatus control server in accordance with Embodiment 3 of the present invention.

FIG. 12 is a functional block diagram illustrating a configuration of the control section of the cleaner robot in accordance with Embodiment 1 of the present invention.

### DESCRIPTION OF EMBODIMENTS

### Embodiment 1

An apparatus control system 1 including an apparatus control server 10 in accordance with the present embodiment is aimed at enhancing convenience in lives of a unit of users by allowing the users of a plurality of household electric apparatuses, which are registered in and belong to a group, to share an announcement, a message, information relating to an area that the users live in, and the like.

According to the apparatus control system 1, electric appliances are registered in a group in the apparatus control system 1, instead of registering users. Specifically, pieces of electric appliance identification information (apparatus number), which are uniquely assigned to respective electric appliances communicably connected with the apparatus control server 10, are registered in the group in the apparatus control system 1. Note that the electric appliances registered in the group in the apparatus control system 1 can be (i) household electric apparatuses which are mainly used in houses or (ii) apparatuses for business use which are mainly used in stores. Hereinafter, such electric appliances are referred to as “notification apparatus” or simply “apparatus”.

The notification apparatuses which are registered in one (1) group can be used by a plurality of users who have a certain common attribute. The common attribute is, for example, a fact that the plurality of users live in an identical apartment house. In this case, the notification apparatuses registered in the one group can be placed in respective apartments of the plurality of users living in the identical apartment house.

Alternatively, the notification apparatuses registered in one group can be placed in a particular location in which users gather who have a certain common purpose. The users who have a common purpose can be, for example, customers who want to do some shopping. In this case, the notification apparatuses registered in the one group can be placed in respective sections in an identical department store. Note that an aspect of using the apparatus control system 1 is not limited to these examples.

(Overview of Apparatus Control System 1)

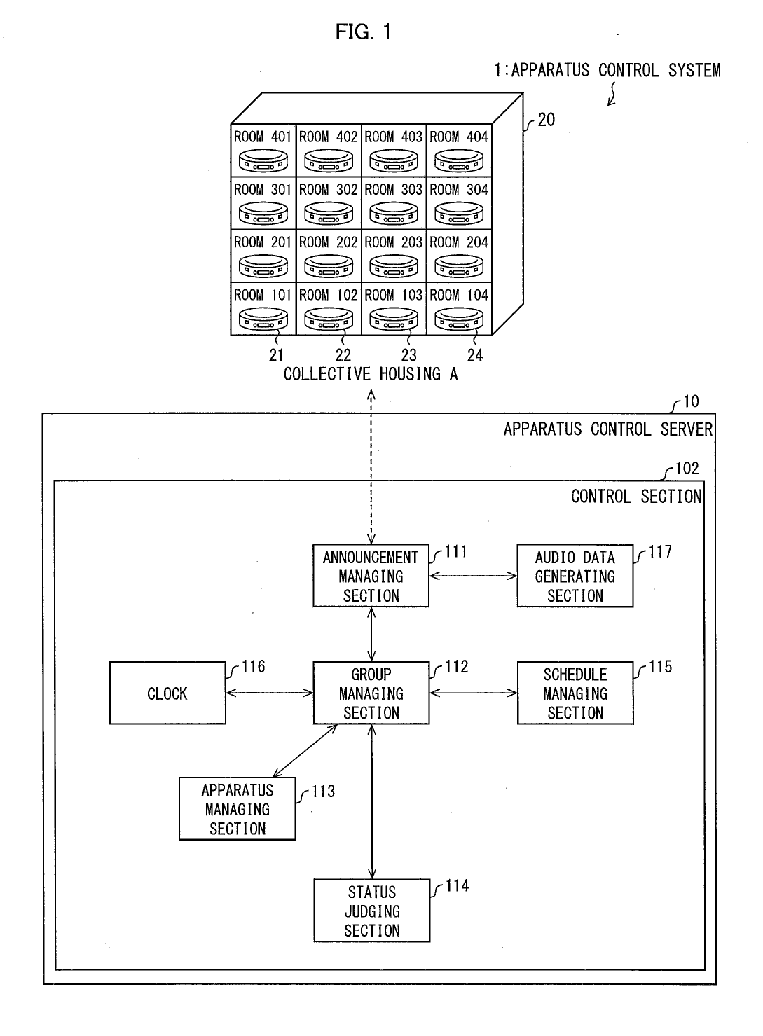

The following description will discuss an overview of the apparatus control system 1 with reference to FIGS. 1 through 3. FIG. 1 is a functional block diagram illustrating a configuration of the apparatus control server 10. Control blocks of the apparatus control server 10 are realized by a computer program which is loaded by a control section (CPU) 102 of the apparatus control server 10 into a main storage device (memory) 103 which is a main storage device. As illustrated in FIG. 1, the apparatus control server 10 includes an announcement managing section 111, a group managing section 112, an apparatus managing section 113, a status judging section 114, a schedule managing section 115, a clock 116, and an audio data generating section 117.

Cleaner robots are placed in respective Room 101 through Room 404 of a collective housing A. Here, a cleaner robot in Room 101 is referred to as “cleaner robot 21”, a cleaner robot in Room 102 is referred to as “cleaner robot 22”, a cleaner robot in Room 103 is referred to as “cleaner robot 23”, a cleaner robot in Room 104 is referred to as “cleaner robot 24”. For convenience of explanation, the reference numerals are given to only the cleaner robots placed in respective Room 101 through Room 104, and no reference numerals are given to the other cleaner robots. Note that all the cleaner robots placed in the respective rooms of the collective housing A have identical configurations.

The following description will discuss, as a main example, a group “collective housing A” which is provided in an apparatus control system. In the group “collective housing A”, 16 cleaner robots are registered which are placed in the respective rooms of the collective housing A.

According to the present embodiment, the apparatus control server 10 is assumed to be configured by one (1) device. Note, however, that the apparatus control server 10 is not limited to this and can be configured by a plurality of devices that take charge of functions of the apparatus control server 10.

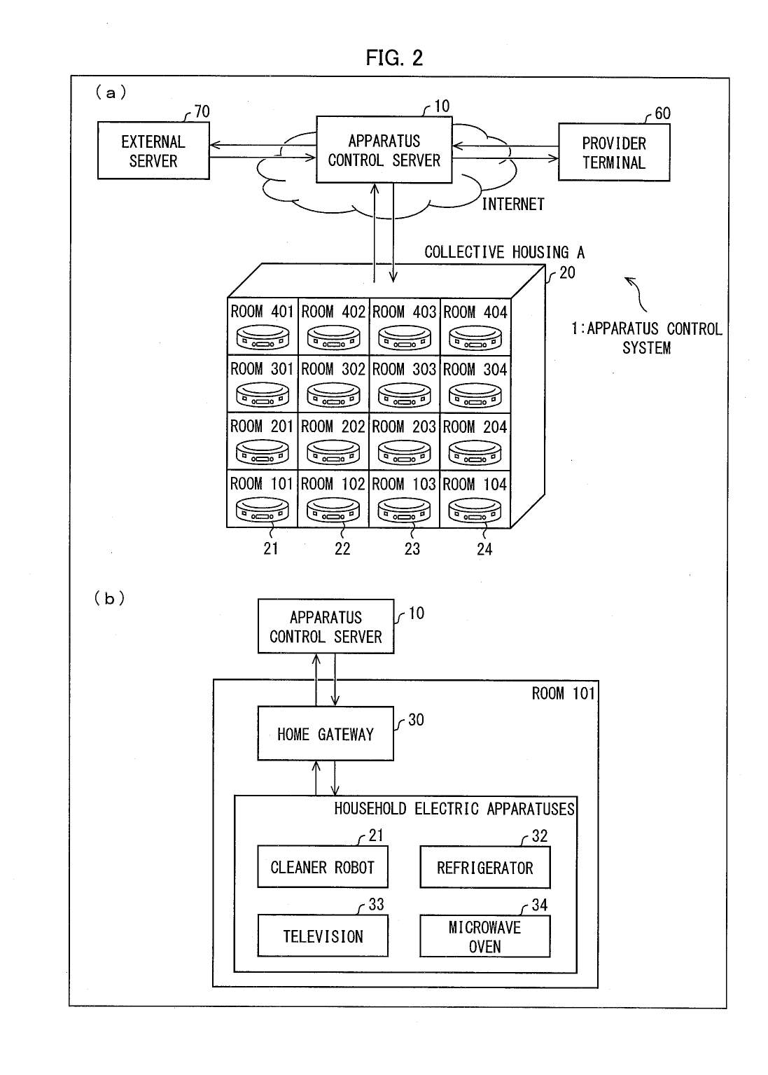

FIG. 2 is a view schematically illustrating the apparatus control system 1 that includes the apparatus control server 10.

As illustrated in (a) of FIG. 2, the apparatus control system 1 includes a provider terminal 60 and an external server 70, in addition to the apparatus control server 10 and the plurality of cleaner robots that are placed in the collective housing A. The apparatus control server 10 is communicably connected with the provider terminal 60 via the Internet, and the apparatus control server 10 is communicably connected with the external server 70 via the Internet.

The provider terminal 60 is used by a provider, who runs the apparatus control system 1, to input a notification schedule into the apparatus control server 10 (details will be described later).

The apparatus control server 10 can be configured to control the cleaner robots, which are the notification apparatuses, to notify information such as a weather forecast of a region in which the collective housing A is located, an operation condition of a nearest train, traffic information, and news of the day. The external server 70 provides these pieces of information to the apparatus control server 10.

(b) of FIG. 2 illustrates a home gateway 30 and household electric apparatuses which are provided in Room 101 of the collective housing A. Via the home gateway 30, the Internet with which the apparatus control server 10 is connected is communicably connected with a LAN provided in Room 101. Household electric apparatuses, i.e., a cleaner robot 21, a refrigerator 32, a television 33, and a microwave oven 34 which are notification apparatuses are connected with the home gateway 30 via the LAN. In the present embodiment, the cleaner robot will be described as an example of the notification apparatus. However, the notification apparatus is not limited to the cleaner robot, and can be a household electric apparatus represented by the refrigerator 32, the television 33, or the microwave oven 34 as illustrated in (b) of FIG. 2.

(Hardware Configuration of Apparatus Control Server 10)

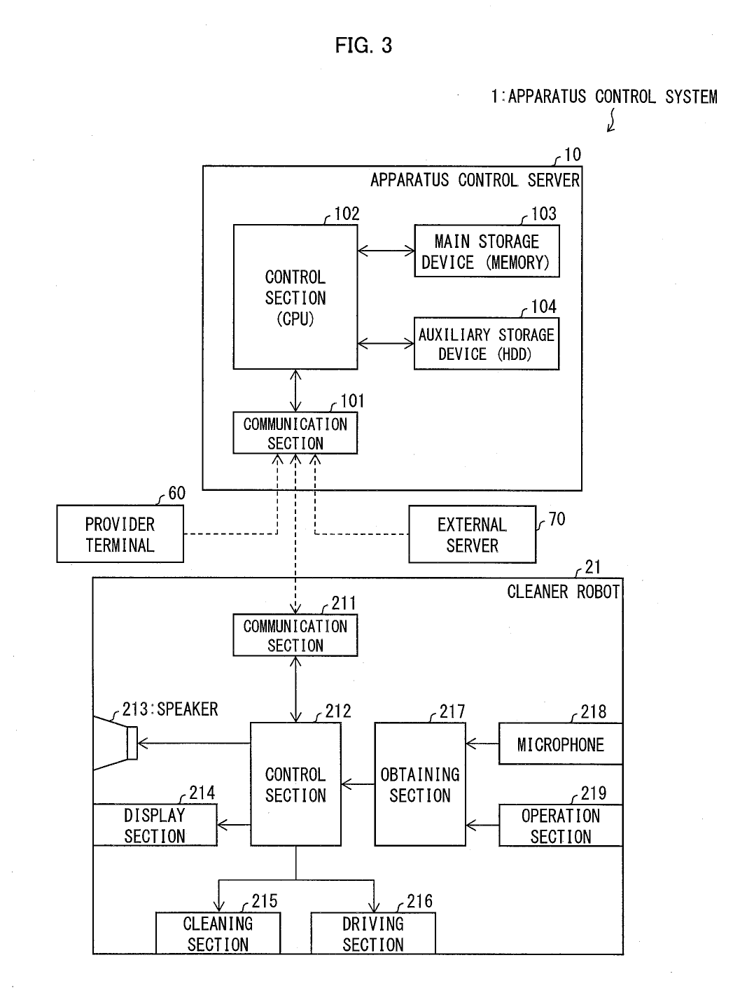

FIG. 3 is a block diagram schematically illustrating a configuration of the apparatus control server 10 and a configuration of the cleaner robot 21. As illustrated in FIG. 3, the apparatus control server 10 includes a communication section 101, a control section 102, a main storage device 103, and an auxiliary storage device 104.

The communication section 101 is an interface for communicably connecting the apparatus control server 10 with the cleaner robot, the provider terminal 60, and the external server 70 via the Internet, the LAN, and the like.

An example of a device which can be used as the control section 102 encompasses a CPU (Central Processing Unit). An example of a device which can be used as the main storage device 103 encompasses a semiconductor RAM (random access memory). An example of a device which can be used as the auxiliary storage device 104 encompasses a hard disk drive (HDD).

In the auxiliary storage device 104, a program is stored which causes the apparatus control server 10 to operate as a server for notifying information. The program includes an announcement managing module, a group managing module, an apparatus managing module, a status judging module, a clock module, a schedule managing module, and an audio data generating module.

The control section 102 executes instructions included in the program, which is loaded on the main storage device 103, so as to control the apparatus control server 10 to function as the server for notifying information. Specifically, the control section 102 carries out instructions included in the program so as to control the apparatus control server 10 to function as an announcement managing section, a group managing section, an apparatus managing section, a status judging section, a clock, a schedule managing section, and an audio data generating section.

(Hardware Configuration of Cleaner Robot)

As illustrated in FIGS. 1 and 2, a total of 16 cleaner robots are placed in the collective housing A. In the present embodiment, the 16 cleaner robots have identical configurations. Here, as an example, a hardware configuration of the cleaner robot 21 placed in Room 101 will be described.

As illustrated in FIG. 3, the cleaner robot 21 includes a communication section 211, a control section 212, a speaker 213, a display section 214, a cleaning section 215, a driving section 216 (moving section), an obtaining section 217, a microphone 218, and an operation section 219.

The communication section 211 is an interface for communicably connecting the cleaner robot 21 with the apparatus control server 10 via the Internet and the LAN.

The speaker 213 outputs an audio based on an instruction given by the control section 212. The speaker 213 can be expressed as an audio data outputting section for outputting audio speaking data by reproducing the audio speaking data (later described).

The display section 214 preferably includes at least any of a display panel represented by a liquid crystal display panel and a light-emitting section that is configured to emit light. The display section 214 has a function to notify the user of information such as an operation state of the cleaner robot 21. Further, the display section 214 is preferably configured to notify the user of information by emission of light.

The cleaning section 215 carries out a function of a cleaner based on an instruction given from the control section 212. The driving section 216 causes the cleaner robot 21 to move based on an instruction given from the control section 212. By controlling the cleaning section 215 and the driving section 216 to cooperate with each other, the cleaner robot 21 can automatically clean inside Room 101.

The microphone 218 obtains audios. The operation section 219 includes, for example, an operation panel and accepts an operation from the user.

The obtaining section 217 supplies an audio, which has been obtained via the microphone 218, to the control section 212 as audio data. Moreover, the obtaining section 217 converts an operation, which the operation section 219 has accepted from the user, into an operation signal and supplies the operation signal to the control section 212. From this, the microphone 218 and the obtaining section 217 can be said as a questioning audio obtaining section for obtaining, as questioning audio data, an audio given by the user.

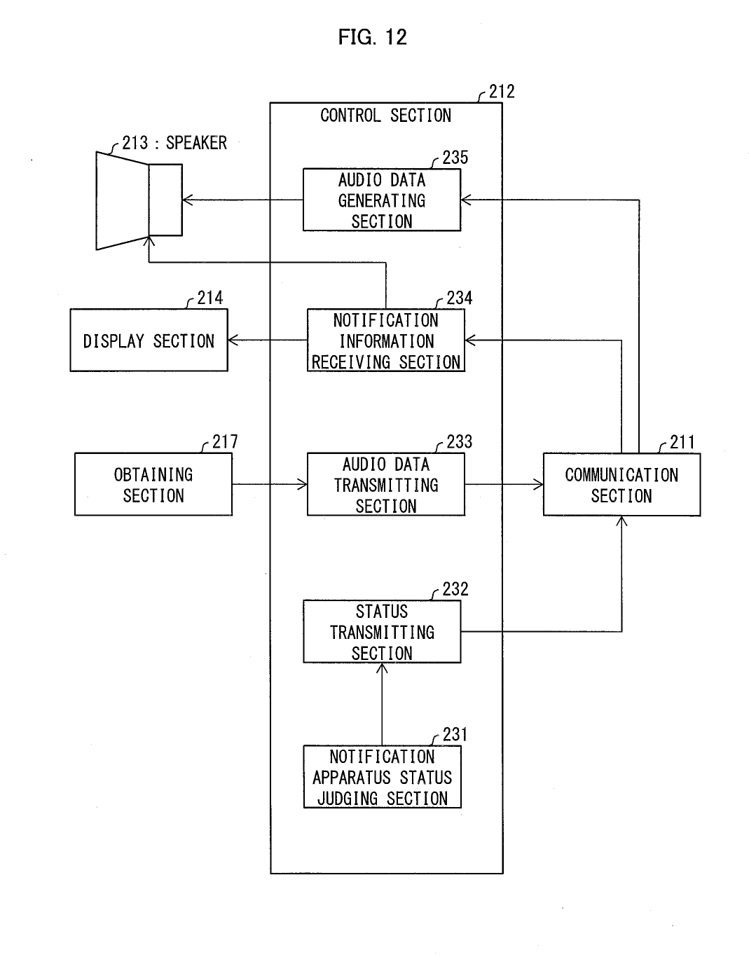

The following description will discuss the control section 212 with reference to FIG. 12. FIG. 12 is a functional block diagram illustrating a configuration of the control section 212 of the cleaner robot 21 in accordance with Embodiment 1 of the present invention.

The control section 212 comprehensively controls the sections of the cleaner robot 21. An example of a device which can be used as the control section 212 encompasses a CPU. Although not illustrated in FIG. 3, the cleaner robot 21 includes a main storage device and an auxiliary storage device. An example of a device which can be used as the main storage device encompasses a semiconductor RAM. An example of a device which can be used as the auxiliary storage device encompasses a semiconductor ROM (Read Only Memory). In the auxiliary storage device, a program is stored which causes the cleaner robot 21 to operate as a notification apparatus and a cleaner.

As illustrated in FIG. 12, the control section 212 can include a control block which functions as a notification apparatus status judging section 231 for judging whether or not a status of the cleaner robot 21 is busy. In a case where the driving section 216 is causing the cleaner robot 21 to move, the notification apparatus status judging section 231 (notification apparatus status judging section) can determine that the status of the cleaner robot 21 is busy. Alternatively, in a case where the cleaning section 215 is carrying out cleaning, the notification apparatus status judging section 231 can determine that the status of the cleaner robot 21 is busy.

In a case where a process (e.g., movement, cleaning) is completed, the notification apparatus status judging section 231 determines that the status of the cleaner robot 21 is not busy.

As illustrated in FIG. 12, the control section 212 can further include a status transmitting section 232 for transmitting, to the apparatus control server 10, a notice indicative of the status of the cleaner robot 21. The status transmitting section 232 is a control block which functions as a status transmitting section. The status transmitting section 232 can transmit, to the apparatus control server 10, a notice which indicates that the status of the cleaner robot 21, which has been determined by the notification apparatus status judging section 231, is changed from “busy” to “not busy” when the status of the cleaner robot 21 has become so.

The control section 212 can transmit the questioning audio data via the communication section 211. Moreover, the control section 212 can receive notification information that contains an answer character string associated with audio information indicated by the questioning audio data. As such, the control section 212 serves as an audio data transmitting section 233 and a notification information receiving section 234 (see FIG. 12).

Furthermore, the control section 212 can include an audio data generating section 235 for generating audio speaking data that represents the answer character string (see FIG. 12).

(Concept of Group)

A group in the apparatus control system 1 is used to manage a plurality of notification apparatuses as one (1) unit. Each of groups has a group name based on which an attribute of a plurality of registered notification apparatuses can be easily grasped. According to the present embodiment, a group having a group name of “collective housing A” is a group for managing, as one (1) unit, notification apparatuses (i.e., cleaner robots) which are placed in the respective rooms of the collective housing A.

The apparatus control system 1 identifies notification apparatuses, which are registered in a group, by apparatus numbers. The apparatus numbers are identification numbers which are uniquely assigned to the respective notification apparatuses.

The following description will discuss an example in which the apparatus numbers are used as information for identifying the notification apparatuses. Note, however, that, according to the apparatus control system 1, the information for identifying the notification apparatuses is not limited to the apparatus numbers. Therefore, information other than a number, e.g., a character string can be used as the apparatus identification information, provided that the notification apparatuses can be identified by the information.

(Construction of Group)

According to the apparatus control system 1 of the present embodiment, it is assumed that the provider, who runs the apparatus control system 1, constructs groups and registers intended notification apparatuses in each of the groups. Note, however, that the constructor of the groups is not limited to the provider. For example, a leader of a residents' association of the collective housing A can be given, from the provider, administrative rights for accessing the provider terminal 60 as a representative for the collective housing A. The representative having the administrative rights can change configurations of groups and construct a new group by accessing the provider terminal 60. For example, the representative can construct groups each of which includes, as a unit, cleaner robots placed in respective rooms of each floor in the collective housing A. Specifically, the representative logs in the apparatus control server 10 via the provider terminal 60 and applies to the apparatus control server 10 for construction of a new group. In such a case, the representative inputs information (such as a group name) which relates to the group. After the construction of the group is completed, the representative inputs, into each of notification apparatuses registered in the group, information (such as apparatus numbers and apparatus names) relating to the notification apparatuses.

For example, it is possible that the representative constructs a group having a group name of “collective housing A first floor” and registers, in the group, a cleaner robot 21 having an apparatus number of D7001, a cleaner robot 22 having an apparatus number of D7002, a cleaner robot 23 having an apparatus number of D7003, and a cleaner robot 24 having an apparatus number of D7004.

[Apparatus Control Server 10]

The apparatus control server 10 designates, from among household electric apparatuses registered in advance, a notification apparatus to carry out a notification operation. Further, the apparatus control server 10 transmits notification information to the notification apparatus so as to control the notification apparatus to notify the notification information. In the present embodiment, the term “notification” collectively refers to actions of conveying information, which the provider running the apparatus control system 1 intends to notify, to a user who is expected to be in the vicinity of the notification apparatus. As an aspect of the notification, the notification apparatus speaks to a user for conveying information by outputting audio data that indicates a content of notification. A method for conveying information to the user is not limited to speaking. For example, the apparatus control server 10 can control the notification apparatus to spatially operate in a manner different from an ordinary manner so as to convey, to the user, information indicating that an extraordinary situation is going on. Alternatively, the apparatus control server 10 can control the light-emitting section, which is provided in the notification apparatus, to regularly emit light so as to convey, to the user, information associated with the regular light emission.

The following description will discuss a configuration of the apparatus control server 10.

(Announcement Managing Section 111)

The announcement managing section 111 is a control block for managing and running the entire apparatus control server 10. As illustrated in FIG. 1, the cleaner robots utilizing the apparatus control server 10 are connected with the announcement managing section 111 via the Internet and the LAN. That is, the announcement managing section 111 is a control block serving as a contact point for the apparatus control system 1.

The announcement managing section 111 can judge whether or not communication with a cleaner robot, which has been designated by the schedule managing section 115 (later described), is available. As such, the announcement managing section 111 is also a control block serving as a communication status judging section.

Moreover, the announcement managing section 111 can judge whether or not the cleaner robot, which has been designated by the schedule managing section 115 (later described), can receive notification information indicating a notification operation.

Moreover, the announcement managing section 111 can obtain, from the cleaner robot which has been designated by the schedule managing section 115, a notification apparatus status indicative of a status of the cleaner robot. As such, the announcement managing section 111 is also a control block serving as a notification apparatus status judging section.

(Group Managing Section 112)

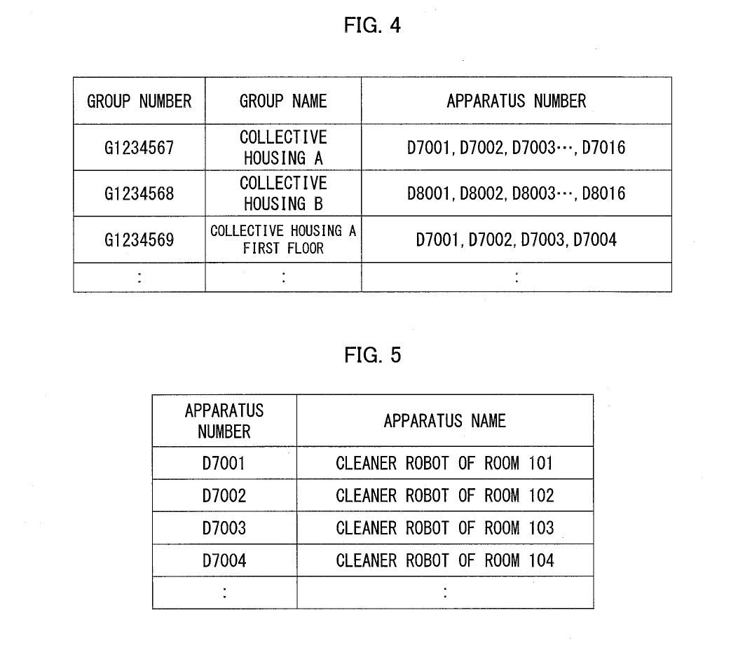

The group managing section 112 is a control block for managing groups, each of which is a unit for notifying information, in the apparatus control server 10. FIG. 4 is a view illustrating an example of a group managing table for managing groups in the apparatus control server 10. The group managing table is stored in a storage section included in the group managing section 112.

In the apparatus control server 10, a plurality of groups are prepared. As illustrated in FIG. 4, in the group managing table, a group number for identifying a group, a group name, and apparatus numbers of respective cleaner robots registered in the group, are associated with each other for each of the groups.

Specifically, in a group having (i) a group number of “G1234567” and (ii) a group name of “collective housing A”, notification apparatuses having respective apparatus numbers of D7001, D7002, D7003, . . . , and D7016 are registered. In a group having (i) a group number of “G1234568” and (ii) a group name of “collective housing B”, notification apparatuses having respective apparatus numbers of D8001, D8002, D8003, . . . , and D8016 are registered. In a group having (i) a group number of “G1234569” and (ii) a group name of “collective housing A first floor”, notification apparatuses having respective apparatus numbers of D7001, D7002, D7003, and D7004 are registered.

According to the present embodiment, the number of notification apparatuses which can be registered in each of groups can have an upper limit. This can be achieved by setting an upper limit to the number of apparatus numbers that can be associated with each of group numbers in the group managing table. Moreover, according to the present embodiment, a certain notification apparatus can be registered in a plurality of different groups. This can be achieved by registering one apparatus number while associating the one apparatus number with a plurality of different group numbers in the group managing table.

(Apparatus Managing Section 113)

The apparatus managing section 113, which is an apparatus managing section, is a control block for managing, for each of groups, all notification apparatuses registered in the group. FIG. 5 is a view illustrating an example of an apparatus managing table for managing notification apparatuses registered in a group in the apparatus control server 10. The apparatus managing table is stored in a storage section (not illustrated) provided in the apparatus managing section 113. FIG. 5 illustrates an apparatus managing table in which apparatus numbers and apparatus names are respectively associated with each other, which relate to respective notification apparatuses registered in a group having a group number of “G123456”.

As illustrated in FIG. 5, an apparatus name of the notification apparatus having the apparatus number of D7001 is “cleaner robot of Room 101”, an apparatus name of the notification apparatus having the apparatus number of D7002 is “cleaner robot of Room 102”, an apparatus name of the notification apparatus having the apparatus number of D7003 is “cleaner robot of Room 103”, and an apparatus name of the notification apparatus having the apparatus number of D7004 is “cleaner robot of Room 104”.

[Schedule Managing Section 115]

The schedule managing section 115 that is a correspondence information managing section manages correspondence information, in which a notification time is associated with notification information for each notification apparatus, based on apparatus numbers of notification apparatuses, notification times, and notification information indicative of a content of at least one notification operation, which have been transmitted from the provider terminal 60. In a case where the schedule managing section 115 has obtained, from the provider terminal 60, an apparatus number of a notification apparatus relating to a new notification, a notification time, and notification information indicative of a content of at least one notification operation, the schedule managing section 115 registers, as a new schedule of the apparatus number, the notification time and the notification information in correspondence information. The registration of the new schedule in the correspondence information is an aspect of managing correspondence information. Note that the notification time indicates a time at which the notification apparatus carries out a notification operation.

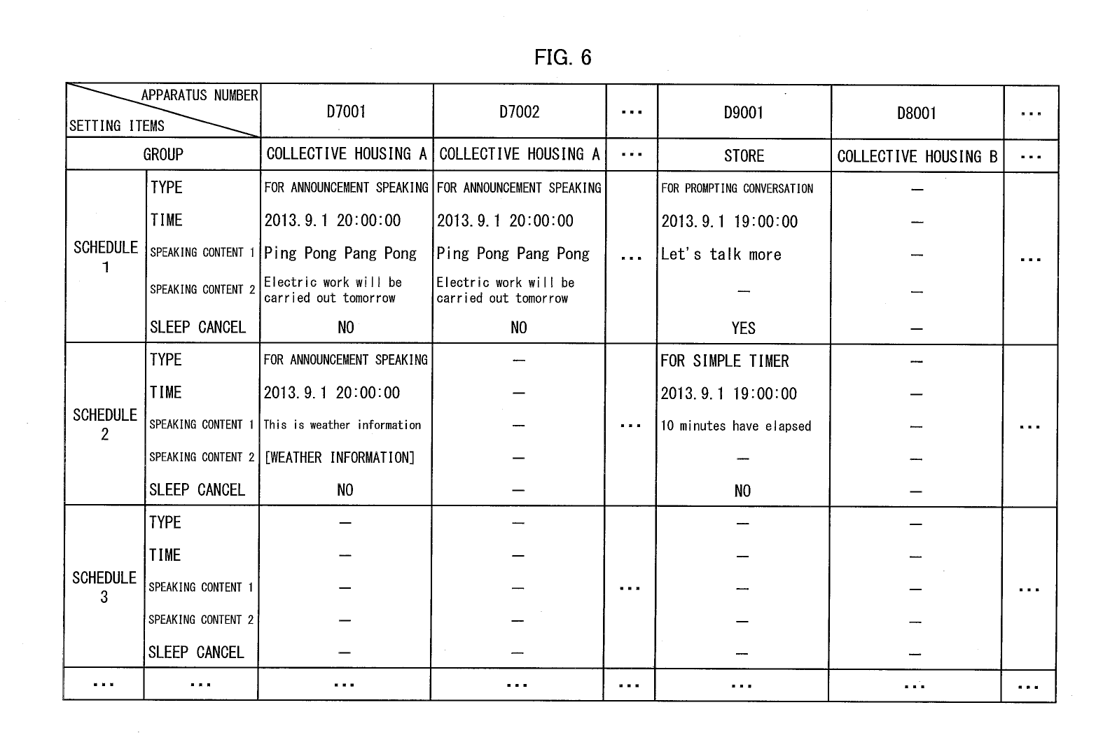

According to the present embodiment, the schedule managing section 115 uses a schedule managing table illustrated in FIG. 6 as an example of correspondence information. The schedule managing table includes, as setting items for specifying a content of speaking or notification, a type, a speaking time, a speaking content 1, a speaking content 2, and a sleep cancel.

The correspondence information is not limited to the schedule managing table, provided that a notification time can be associated with notification information for each notification apparatus.

In the correspondence information, a notification time and notification information can be associated with each other for each group. In such a case, the schedule managing section 115 is to collectively associate a notification time and notification information with notification apparatuses included in the group. In other words, the schedule managing section 115 collectively registers (i) a notification time at which a notification operation is carried out and notification information indicating a content of at least one notification operation, with respect to a plurality of notification apparatuses.

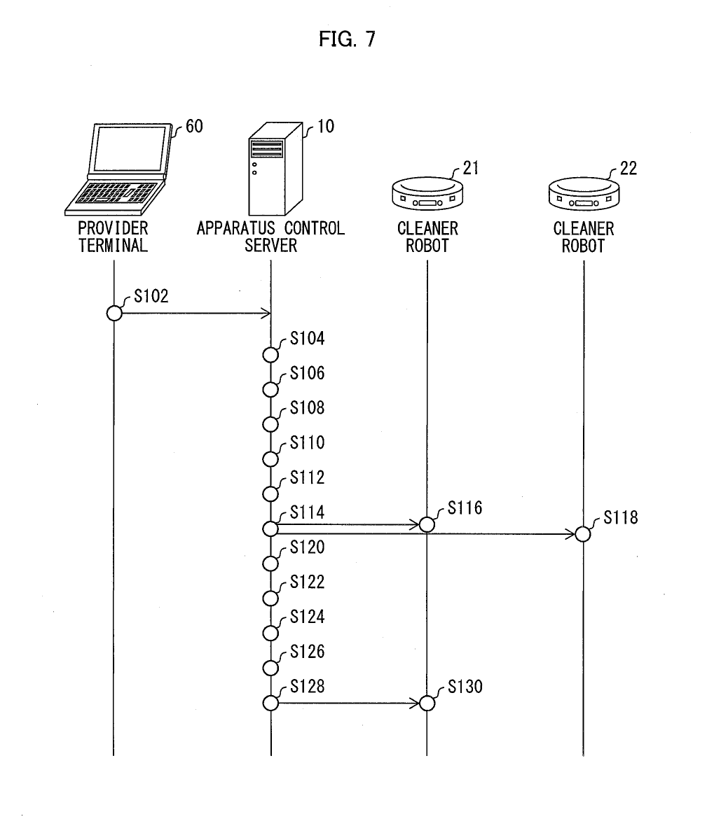

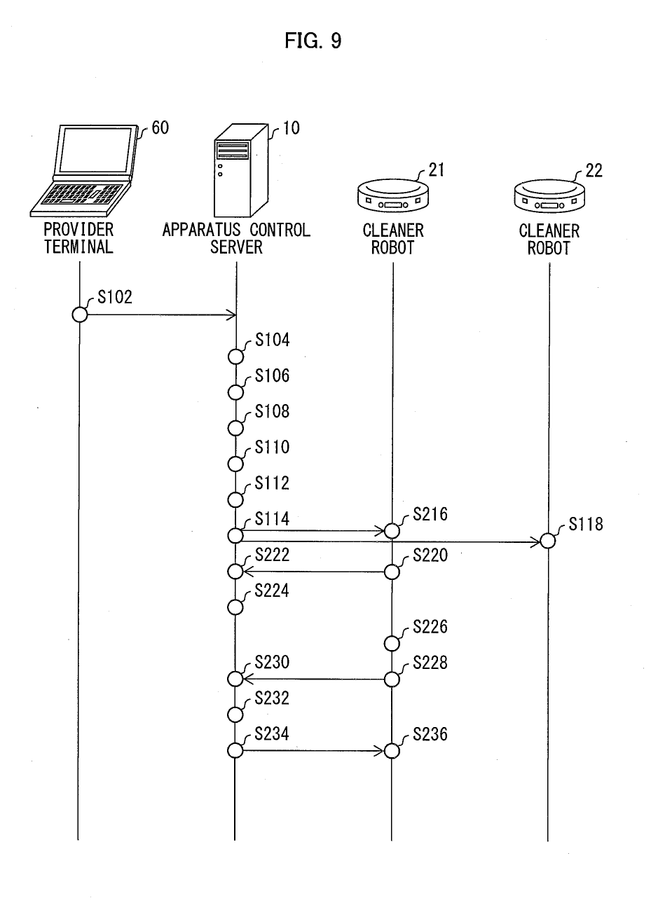

Note that management (including registration) of the schedule managing table carried out by the schedule managing section 115 will be described later with reference to sequence diagrams illustrated in FIGS. 7 and 9.

Moreover, the schedule managing section 115 (i) designates a notification apparatus to carry out a notification operation and (ii) determines notification information indicating a content of the notification operation, based on a speaking schedule registered in the schedule managing table. As such, in other words, the schedule managing section 115 serves as (i) a notification apparatus designating section configured to designate a notification apparatus to carry out a notification operation with reference to the correspondence information and also (ii) a notification information determining section configured to determine notification information, which indicates a content of the notification operation, with reference to the correspondence information.

The schedule managing section 115 obtains, from the clock 116, time and date information that indicates a date and a time (hereinafter, also referred to as time and date) at the time point. When time and date indicated by the time and date information reaches a speaking time on the schedule registered in the schedule managing table, the schedule managing section 115 supplies, to the announcement managing section 111, the schedule as information to be spoken. As such, the schedule managing section 115 can be expressed as a timer that outputs a trigger for carrying out the schedule registered in the schedule managing table.

Alternatively, the schedule managing section 115 can immediately transmit, without specifying time and date, notification information when a setting other than time and date is made. In such a configuration, correspondence information managed by the schedule managing section 115 does not need to include a notification time. That is, in such a configuration, the schedule managing section 115 is to manage correspondence information in which notification information is associated with each notification apparatus. Moreover, in such a configuration, the schedule managing section 115 can collectively associate notification information with notification apparatuses included in a group. In other words, the schedule managing section 115 can collectively register notification information, which indicates a content of at least one notification operation, with respect to a plurality of notification apparatuses.

[Status Judging Section 114]

The status judging section 114, which is a status judging section, judges whether or not a notification apparatus, which has been designated by the schedule managing section 115, is in a status of busy, and supplies a judgment result to the announcement managing section 111.

In a case where the announcement managing section 111 is transmitting notification information to a notification apparatus, the status judging section 114 determines that a status of the notification apparatus is busy. In a case where a predetermined time period has not elapsed from a time point at which the announcement managing section 111 transmitted notification information to a notification apparatus, the status judging section 114 determines that a status of the notification apparatus is busy.

In a case where the announcement managing section 111 transmitted notification information to a notification apparatus and then the announcement managing section 111 has received, from the notification apparatus, a notice indicating that the notification apparatus is busy, the status judging section 114 determines that a status of the notification apparatus is busy.

In this specification, the phrase “a status of the notification apparatus is busy” indicates that the notification apparatus is in a state in which the notification apparatus cannot notify notification information or does not notify notification information, and specifically encompasses the following cases:
A case where the announcement managing section 111 cannot communicate with the notification apparatus. Examples of this encompass cases where a power source of the notification apparatus is turned off, the notification apparatus is in a sleep state, and the Internet or the LAN is not connected.
A case where the notification apparatus cannot receive notification information although communication between the announcement managing section 111 and the notification apparatus is established.
A case where the notification apparatus cannot notify information although communication between the announcement managing section 111 and the notification apparatus is established and the notification apparatus can receive notification information. Examples of this encompass a case where the notification apparatus is notifying another notification information. Note that, in such a case, the notification apparatus can transmit, to the apparatus control server 10, a notification unable notice which indicates a state of unable to notify information. In a case where a notification apparatus status obtaining section of the apparatus control server 10 has obtained a notification unable notice, the status judging section 114 determines that a status of the notification apparatus is busy.
A case where the notification apparatus is in a state of able to notify notification information but is carrying out another operation and it is not preferable to notify information (i.e., notification should not be carried out). An example of this encompasses a case where a cleaner robot, which is the notification apparatus, is carrying out operations such as cleaning and moving. When such operations are being carried out, sounds are made due to the cleaning and the moving. Therefore, in such a situation, it is not preferable for the cleaner robot to notify information. Note that, in such a case, the notification apparatus can transmit, to the apparatus control server 10, a notification inappropriate notice which indicates a state in which notification should not be carried out. In a case where the notification apparatus status obtaining section of the apparatus control server 10 has obtained the notification inappropriate notice, the status judging section 114 determines that a status of the notification apparatus is busy.

From these, in this specification, the phrase “status of the notification apparatus is busy” can be paraphrased into “state in which it is inappropriate to transmit, to a speaking device, an instruction on speaking”.

[Audio Data Generating Section 117]

When the audio data generating section 117 has received, from the announcement managing section 111, a speaking content and an instruction on generating audio speaking data based on the speaking content, the audio data generating section 117 generates audio speaking data indicative of the speaking content, and supplies the audio speaking data thus generated to the announcement managing section 111.

[Process Flow in Apparatus Control System]

The following description will discuss a flow of processes carried out in the apparatus control system 1, with reference to FIG. 7.

[Registering Process on Schedule Managing Table]

Step S102: The provider which provides the apparatus control system 1 inputs, on a schedule registering screen displayed on the provider terminal 60, a cleaner robot intended to speak (speaking target apparatus), an intended time of speaking (speaking time), and an intended content to be spoken (speaking content), so as to input a speaking (notification, announcement) schedule to the apparatus control server 10. According to the present embodiment, the speaking target apparatuses are cleaner robots belonging to the group “collective housing A”, a speaking time is “September 1, 2013, 20:00:00”, and speaking contents are a speaking content 1 “Ping Pong Pang Pong” and a speaking content 2 “Electric work will be carried out tomorrow”.

In the descriptions below, the speaking target apparatus, the speaking time, and the speaking content are also collectively referred to as “registration information”. Moreover, the registration information can include a speaking type which is information indicating an attribute of an intended content to be spoken.

[Designation of Speaking Target Apparatus]

When a speaking target apparatus is designated, a plurality of cleaner robots belonging to a group can be collectively selected as speaking target apparatuses by selecting the group. In order to designate a group to which a plurality of cleaner robots belong, the provider terminal 60 can accept, from the provider, an input of “collective housing A”, which is the name of the group to be designated. Alternatively, the provider terminal 60 can be configured to display, in a selectable manner, names of groups registered in the apparatus control server 10. According to the configuration, the provider does not need to input a group name, and can designate a group, to which a plurality of cleaner robots belong, by selecting any of displayed group names.

Alternatively, instead of collectively designating, as speaking target apparatuses, a plurality of cleaner robots registered in a group, the provider can designate a single cleaner robot as a speaking target apparatus in the step of designating a speaking target apparatus. In this case, (i) one (1) cleaner robot can be designated as a speaking target apparatus by separately selecting the cleaner robot or (ii) a group to which only one cleaner robot belongs is constructed and the one cleaner robot can be designated as a speaking target apparatus by designating the group.

In order to designate a separate cleaner robot, the provider terminal 60 can accept, from the provider, an input of a name (e.g., “cleaner robot of Room 101”) of a cleaner robot to be designated. Alternatively, the provider terminal can accept an input of an apparatus number (e.g., “D7001”) of a cleaner robot to be designated. Alternatively, the provider terminal 60 can be configured to display, in a selectable manner, names or apparatus numbers of cleaner robots registered in the apparatus control server 10.

In this case, it may be bothersome for the provider to select an intended speaking target apparatus from among all the cleaner robots registered in the apparatus control server 10. This is because the number of cleaner robots registered in the apparatus control server 10 may be extremely large. In order to more easily select a separate cleaner robot, first, the provider terminal 60 can display, in a selectable manner, names of groups registered in the apparatus control server 10. The provider selects a group, to which an intended cleaner robot belongs, from the displayed groups. Next, in accordance with a result of selection by the provider, the provider terminal 60 displays, in a selectable manner, names of all cleaner robots belonging to the selected group. The provider can designate a separate cleaner robot by selecting any of the displayed names of the cleaner robots.

[Input of Speaking Time]

A speaking time can be inputted by the provider via a keyboard. Alternatively, the provider terminal 60 can be configured to display times, which have been registered in advance, as speaking times in a selectable manner. The provider terminal 60 can include, on the schedule registering screen, a pull-down button for accepting input of a speaking time. According to the configurations, the provider can easily input an intended speaking time to the provider terminal 60.

[Input of Speaking Content]

A speaking content can be inputted by the provider via an input device such as a keyboard or can be selected by the provider from among fixed phrases prepared in advance.

The provider terminal 60 transmits, to the apparatus control server 10, the registration information thus inputted.

Step S104: The communication section 101 of the apparatus control server 10 supplies, to the control section 102, registration information which has been received from the provider terminal 60 and indicates a content to be spoken. The control section 102 supplies the registration information to the group managing section 112 that is a functional block realized by a program, which is loaded and executed on the main storage device 103, via the announcement managing section 111. In a case where the registration information contains a plurality of speaking target apparatuses, i.e., the plurality of cleaner robots belonging to the group “collective housing A”, the group managing section 112 obtains apparatus numbers “D7001”, “D7002”, “D7003”, . . . , “D7016” of the respective plurality of cleaner robots belonging to the group “collective housing A”, with reference to the group managing table.

Meanwhile, in a case where the registration information contains a separate speaking target apparatus, i.e., the cleaner robot having the name “cleaner robot of Room 101”, the apparatus managing section 113 obtains the apparatus number “D7001” which is associated with the name “cleaner robot of Room 101”, with reference to the apparatus managing table. Note that, in a case where the speaking target apparatus contained in the registration information is indicated by the apparatus number “D7001” of the cleaner robot to be designated, it is not necessary to refer to the apparatus managing table for obtaining the apparatus number.

The group managing section 112 supplies the registration information and the apparatus number(s) of the speaking target apparatus(es) to the schedule managing section 115.

Step S106 (notification apparatus designating step, notification information determining step, correspondence information managing step): The schedule managing section 115 newly registers a speaking schedule in the schedule managing table stored in the HDD 104, based on the registration information and the apparatus numbers (“D7001” through “D7016”) of the respective speaking target apparatuses thus supplied.

Specifically, the schedule managing section 115 registers, as a schedule 1, a speaking time and a speaking content, which are the registration information, in a column of the apparatus number D7001 in the schedule managing table. Therefore, in an intersection of the column “apparatus number D7001” and a row “schedule 1” in the schedule managing table, a speaking time “September 1, 2013, 20:00:00”, a speaking content 1 “Ping Pong Pang Pong”, and a speaking content 2 “Electric work will be carried out tomorrow” are registered.

Similarly, the schedule managing section 115 registers, as the schedule 1, a speaking time and a speaking content, which are the registration information, in a column of the apparatus number D7002 in the schedule managing table. Therefore, in an intersection of the column “apparatus number D7002” and the row “schedule 1” in the schedule managing table, a speaking time “September 1, 2013, 20:00:00”, a speaking content 1 “Ping Pong Pang Pong”, and a speaking content 2 “Electric work will be carried out tomorrow” are registered.

Similarly, the schedule managing section 115 registers, as the schedule 1, a speaking time and a speaking content, which are the registration information, in a column of each of the apparatus numbers “D7003” through “D7016” (which are not illustrated in the schedule managing table of FIG. 6).

By appropriately repeating the steps S102 through S106, the provider can register speaking schedules in the apparatus control server 10 via the provider terminal 60.

FIG. 6 illustrates the schedule managing table in which a schedule 2 of the apparatus number “D7001” and schedules 1 and 2 of the apparatus number “D9001” are registered in addition to the registered schedules above described. Specifically, in an intersection of the column “apparatus number D7001” and the row “schedule 2”, a speaking time “September 1, 2013, 20:00:00”, a speaking content 1 “This is electricity information”, and a speaking content 2 “[Weather information]” are registered. In an intersection of the column “apparatus number D9001” and the row “schedule 1”, a speaking time “September 1, 2013, 19:00:00” and a speaking content 1 “Let's talk more” are registered. In an intersection of the column “apparatus number D9001” and the row “schedule 2”, a speaking time “September 1, 2013, 19:00:00” and a speaking content 1 “10 minutes have elapsed” are registered.

The schedule 2 of the apparatus number “D7001” is an example of a schedule in which one (1) cleaner robot has been designated as the speaking target apparatus.

[Speaking Process Based on Schedule Managing Table]

Step S108: The schedule managing section 115 refers to time and date information supplied by the clock 116. When time and date indicated by the time and date information reaches a speaking time of a schedule registered in the schedule managing table, the schedule managing section 115 manages registration information of the schedule whose speaking time has arrived, and supplies the registration information to the announcement managing section 111 as information to be spoken.

For example, in the schedule managing table illustrated in FIG. 6, the speaking times of the schedules 1 and 2 of the apparatus number “D7001” and the schedule 1 of the apparatus number “D7002” are set to September 1, 2013, 20:00:00. Therefore, in a case where time and date indicated by the time and date information supplied from the clock 116 reach September 1, 2013, 20:00:00, the schedule managing section 115 manages, as information to be spoken, the registration information in the schedule 1 of the apparatus number “D7001” and the registration information in the schedule 1 of the apparatus number “D7002”, and supplies the pieces of registration information to the announcement managing section 111.

Note that the speaking times of the schedules 1 and 2 of the apparatus number “D7001” are set to September 1, 2013, 20:00:00. In a case where a plurality of schedules of one notification apparatus are thus set by identical speaking times, the schedule managing section 115 is preferably configured to manage and select, as information to be spoken, any one of the plurality of schedules set by the identical speaking times. In other words, for one (1) notification apparatus, information to be spoken managed by the schedule managing section 115 is preferably one (1) schedule. According to the configuration, it is possible to prevent a case where a plurality of speaking contents are registered as a plurality of schedules, the plurality of speaking contents are collectively transmitted to one notification apparatus, and the user is confused by hearing the plurality of speaking contents.

The method of selecting, as information to be spoken, any one of the plurality of schedules set by the identical speaking times is not limited to a particular one. For example, in a case where a plurality of schedules of one notification apparatus are set by identical speaking times, the schedule managing section 115 can be configured to select, as information to be spoken, a schedule whose schedule number is the lowest.

Step S110 (status judging step, communication status judging step, status obtaining step): The announcement managing section 111 obtains, from the schedule managing section 115, the registration information of the schedule 1 of the apparatus number “D7001” and the registration information of the schedule 1 of the apparatus number “D7002”. The announcement managing section 111 instructs the status judging section 114 to judge whether or not a status of the cleaner robot 21 whose apparatus number is “D7001” is busy and whether or not a status of the cleaner robot 22 whose apparatus number is “D7002” is busy.

At the time, the announcement managing section 111 (transmitting section) is not transmitting, to the cleaner robot 21, notification information which indicates a content of a notification operation. In other words, this does not fall under the case where the notification information, which indicates the content of the notification operation, is being transmitted to the cleaner robot 21. Moreover, a predetermined time period has elapsed from a time point at which the announcement managing section 111 transmitted notification information before. In other words, this does not fall under a case where the predetermined time period has not elapsed from the time point at which notification information was transmitted before. Therefore, the status judging section 114 determines that a status of the cleaner robot 21 whose apparatus number is “D7001” is “not busy”. Note that, hereinafter, the predetermined time period is referred to as “first predetermined time period”.

Similarly, the announcement managing section 111 is not transmitting, to the cleaner robot 22, notification information which indicates a content of a notification operation. Moreover, the first predetermined time period has elapsed from a time point at which the announcement managing section 111 transmitted notification information to the cleaner robot 21 before. Therefore, the status judging section 114 determines that a status of the cleaner robot 22 whose apparatus number is “D7002” is “not busy”.

The status judging section 114 supplies, to the announcement managing section 111, the status “not busy” of the apparatus number “D7001” and the status “not busy” of the apparatus number “D7002”.

According to the present embodiment, the first predetermined time period is 1 minute. Note, however, that the first predetermined time period is not limited to 1 minute, and can be appropriately determined by the provider, who provides the apparatus control system 1, in consideration of user-friendliness and the like.

Step S112: Upon receipt of the judgment result “not busy” from the status judging section 114, the announcement managing section 111 instructs the audio data generating section 117 to generate audio speaking data that indicates the speaking content 1 “Ping Pong Pang Pang” and the speaking content 2 “Electric work will be carried out tomorrow” which are contained in the registration information of the schedule supplied from the schedule managing section 115. Upon receipt of the instruction, the audio data generating section 117 generates speaking audio data “Ping Pong Pang Pong, electric work will be carried out tomorrow” and supplies the speaking audio data to the announcement managing section 111.

Step S114 (transmitting step): The announcement managing section 111 transmits, via the communication section 101, (i) the speaking audio data “Ping Pong Pang Pong, electric work will be carried out tomorrow” obtained from the audio data generating section 117 and (ii) a control signal for speaking (reproducing) the speaking audio data to the cleaner robot 21 whose apparatus number is “D7001” and the cleaner robot 22 whose apparatus number is “D7002”.

Here, the announcement managing section 111 is assumed to transmit (more precisely, control the communication section 101 to transmit) (i) the speaking audio data and (ii) the control signal for speaking the speaking audio data at the time of 20:00:05 on September 1, 2013.

Step S116: The communication section 211 of the cleaner robot 21 supplies, to the control section 212, the (i) the speaking audio data and (ii) the control signal for speaking the speaking audio data, which have been received from the apparatus control server 10. Upon receipt of (i) the speaking audio data and (ii) the control signal for speaking the speaking audio data, the control section 212 reproduces the speaking audio data so that the speaker 213 speaks “Ping Pong Pang Pong, electric work will be carried out tomorrow”.

Step S118: Since the cleaner robot 22 has the configuration identical with that of the cleaner robot 21, a process in the step S118 is similar to that of the step S116. Specifically, the communication section of the cleaner robot 22 supplies, to the control section of the cleaner robot 22, (i) the speaking audio data and (ii) the control signal for speaking the speaking audio data which have been received from the apparatus control server 10. Upon receipt of (i) the speaking audio data and (ii) the control signal for speaking the speaking audio data, the control section of the cleaner robot 22 reproduces the speaking audio data so that the speaker of the cleaner robot 22 speaks “Ping Pong Pang Pong, electric work will be carried out tomorrow”.

[Audio Data Generating Section]

According to the present embodiment, the apparatus control server 10 includes the audio data generating section 117 for generating speaking audio data, and the speaking audio data thus generated is transmitted by the apparatus control server 10 to a cleaner robot. Note, however, that the audio data generating section for generating audio data that indicates speaking contents (speaking contents 1 and 2) can be included in the cleaner robot (notification apparatus) instead of in the apparatus control server 10.

In a case where the cleaner robot 21 includes the audio data generating section 235, the announcement managing section 111 transmits, to the cleaner robot 21, (a) a speaking content and (b) a control signal for speaking the speaking content. The control section 212 of the cleaner robot 21, which has obtained (a) the speaking content and (b) the control signal for speaking the speaking content, instructs the audio data generating section 235 of the notification apparatus to generate audio speaking data that represents the speaking content. Upon receipt of the instruction, the audio data generating section 235 of the cleaner robot 21 generates speaking audio data “Ping Pong Pang Pong, electric work will be carried out tomorrow”, and supplies the speaking audio data to the control section 212. The control section 212 reproduces the speaking audio data so that the speaker 213 speaks “Ping Pong Pang Pong, electric work will be carried out tomorrow”.

Note that “Ping Pong Pang Pong” can be a voice or a chime (i.e., instrument sound). In the example illustrated in FIG. 6, “Ping Pong Pang Pong” is set as the speaking content 1. Note that, alternatively, an item can be set to select whether or not to sound “Ping Pong Pang Pong” before or after speaking.

In the case where “Ping Pong Pang Pong” is sounded before speaking, it is sounded in order to draw the user's attention or not to surprise the user by sudden speaking. As another example for not surprising the user, a sound volume can be turned down at the beginning of speaking.

[Information Notification and the Like Other than Speaking]

In the above description, notification of information is carried out by speaking. Note, however, that information can be notified by an operation other than speaking, or by a combination of speaking and an operation other than speaking. The operation other than speaking can be, for example, a display on the display panel, lighting or blinking of the light-emitting section, or an operation by the driving section 216.

On the display panel, a text of a speaking content can be displayed, graphics corresponding to a speaking content can be displayed, or graphics of a predetermined character speaking in accordance with an audio can be displayed.

The light-emitting section can be set in terms of color, lighting, and blinking, e.g., the light-emitting section is set to light in green for a normal announcement (such as weather forecast) and is set to blink in red for an urgent announcement. Alternatively, the light-emitting section can blink in accordance with an audio of speaking.

The operation by the driving section 216 can be determined (i.e., selected) from variety of operations such as “rotation” (i.e., rotate in the same position) and “dance” (i.e., move like dancing).

Alternatively, the variety of operations can include “cleaning”, and a cleaning operation can be carried out when the “cleaning” is designated. In such a case, “Ping Pong Pang Pong, I'm going to do the cleaning now” can be spoken or not. Alternatively, a configuration can be employed in which a remotely controllable operation can be designated.

As such, it is preferable to manage the information notification and the like other than speaking in the schedule managing table illustrated in FIG. 6.

[Process in Busy Status]

In the step S108, in a case where a plurality of schedules of a certain notification apparatus are set by identical speaking times, the schedule managing section 115 selects any one of the plurality of schedules, which are set by the identical speaking times, as information to be spoken. Specifically, from the schedules 1 and 2 of the apparatus number “D7001” which are set by the identical speaking times, the schedule managing section 115 manages the registration information of the schedule 1 as information to be spoken, and supplies the registration information of the schedule 1 to the announcement managing section 111. Moreover, in the step S114, the announcement managing section 111 transmits, to the cleaner robot 21 whose apparatus number is “D7001”, (i) the speaking audio data obtained from the audio data generating section 117 and (ii) the control signal for speaking the speaking audio data. Therefore, at the time point at which the step S114 is carried out, no schedule exists which is managed by the schedule managing section 115 as information to be spoken by the cleaner robot 21 having the apparatus number of “D7001”. Accordingly, the schedule managing section 115 can manage registration information of a new schedule as information to be spoken by the cleaner robot 21 having the apparatus number of “D7001”.

Step S120: As with the step S108, when the time and date indicated by time and date information reaches a speaking time of a schedule registered in the schedule managing table, the schedule managing section 115 manages registration information of the schedule whose speaking time has arrived, and supplies the registration information to the announcement managing section 111 as information to be spoken. Here, the speaking time of the schedule 2 of the apparatus number “D7001” is set to September 1, 2013, 20:00:00, and the time and date indicated by the time and date information have reached the speaking time. Therefore, the schedule managing section 115 manages the registration information at the intersection of the column “apparatus number D7001” and the row “schedule 2” as information to be spoken, and supplies the registration information to the announcement managing section 111.

Step S122: The announcement managing section 111 obtains the registration information of the schedule 2 of the apparatus number “D7001” from the schedule managing section 115. The announcement managing section 111 instructs the status judging section 114 to judge whether or not a status of the cleaner robot 21 whose apparatus number is “D7001” is busy. In other words, the step S122 is a status judging step similar to the step S110.

In this case, the time and date indicated by the time and date information supplied from the clock 116 is September 1, 2013, 20:00:30.

At this time point, the announcement managing section 111 is not transmitting, to the cleaner robot 21, notification information which indicates a content of a notification operation. However, in the step S114, the announcement managing section 111 transmitted, to the cleaner robot 21 having the apparatus number “D7001”, (i) the speaking audio data “Ping Pong Pang Pong, electric work will be carried out tomorrow” obtained from the audio data generating section 117 and (ii) the control signal for speaking (reproducing) the speaking audio data at the time point of September 1, 2013, 20:00:05. Therefore, a time period from when the announcement managing section 111 previously transmitted the speaking audio data (i.e., notification information) to this time point is 25 seconds, and accordingly 1 minute (i.e., first predetermined time period) has not elapsed. This falls within the case where the first predetermined time period has not elapsed from the time point at which the announcement managing section 111 transmitted the notification information. From this, the status judging section 114 determines that the status of the apparatus number “D7001” is “busy”, and supplies this judgment result to the announcement managing section 111.

Step S124: The announcement managing section 111 obtains the judgment result “busy” as the status of the apparatus number “D7001”. In this case, the announcement managing section 111 preferably waits to transmit, to the cleaner robot 21 whose apparatus number is “D7001”, the speaking contents 1 and 2 that are registration information described in the intersection of the column “D7001” and the row “schedule 2”, and more preferably cancels the waiting state after a predetermined time period has elapsed. The predetermined time period for waiting is not limited to a particular period, and can be determined by the provider as appropriate. According to the present embodiment, the predetermined time period is 1 minute.

Step S126: When the predetermined time period, i.e., 1 minute has elapsed, the announcement managing section 111 instructs the audio data generating section 117 to generate speaking audio data that indicates a speaking content 1 “This is weather information” and a speaking content 2 “[weather information]”.

Here, the speaking content 2 “[weather information]” indicates weather information for a region in which the collective housing A is located, and the weather information is obtained from an external server. In this case, the announcement managing section 111 obtains, from the external server, text data of weather information for the region (in this case, Shinagawa-ku) in which the collective housing A is located.

Upon receipt of the instruction on generating speaking audio data, the audio data generating section 117 generates speaking audio data “This is weather information, today's weather of Shinagawa-ku will be fine all day”, and supplies the speaking audio data to the announcement managing section 111.

Step S128: The announcement managing section 111 transmits (i) the speaking audio data “This is weather information, today's weather of Shinagawa-ku will be fine all day” obtained from the audio data generating section 117 and (ii) a control signal for speaking (reproducing) the speaking audio data, to the cleaner robot 21 having the apparatus number “D7001” via the communication section 101.

Step S130: The communication section 211 of the cleaner robot 21 supplies, to the control section 212, (i) the speaking audio data and (ii) the control signal for speaking the speaking audio data which have been received from the apparatus control server 10. Upon receipt of (i) the speaking audio data and (ii) the control signal for speaking the speaking audio data, the control section 212 reproduces the speaking audio data so that the speaker 213 speaks “This is weather information, today's weather of Shinagawa-ku will be fine all day”.

### Modification Example

In the above described step S124, in a case where the announcement managing section 111 has obtained “busy” as the status of the apparatus number “D7001”, the announcement managing section 111 preferably waits to transmit the speaking contents 1 and 2 to the cleaner robot 21, and more preferably cancels the waiting state after the predetermined time period has elapsed. The following description will discuss a modification example of a process which is carried out by the control section 102 in a case where a status “busy” is obtained as the status of the apparatus number “D7001”.

In the modification example, when the announcement managing section 111 has obtained a status “busy” as the status of the apparatus number “D7001”, the announcement managing section 111 notifies the schedule managing section 115 that the status of the apparatus number “D7001” is “busy”.

Upon receipt of the notice, the schedule managing section 115 in accordance with this modification example resets the speaking time of the schedule 2 of the apparatus number “D7001” to a speaking time which is delayed by a second predetermined time period from September 1, 2013, 20:00:00. According to the modification example, the second predetermined time period is not limited to a particular period, and can be determined as appropriate by taking into consideration user-friendliness. For example, the second predetermined time period can be set to 1 minute.

### Embodiment 2

The following description will discuss another embodiment of the present invention with reference to FIG. 9. For convenience, the same reference numerals are given to constituent members which have functions identical with those described in Embodiment 1, and descriptions regarding such constituent members are omitted.

The steps S102 through S114 and the step S118 are identical with those described in Embodiment 1, and therefore are not repeatedly described here.

Step S216: The communication section 211 of the cleaner robot 21 supplies, to the control section 212, (i) the speaking audio data and (ii) the control signal for speaking the speaking audio data which have been received from the apparatus control server 10. At this time point, the cleaner robot 21 is assumed to be cleaning in response to an instruction given by the user, i.e., a resident of Room 101.

The control section 212 of the cleaner robot 21 in accordance with the present embodiment includes a notification apparatus status judging section 231 for judging whether or not a status of the cleaner robot 21 itself is busy. In a case where, for example, the cleaning section 215 is carrying out cleaning, the notification apparatus status judging section 231 determines that the status of the cleaner robot 21 itself is busy. Note that the case where the cleaning section 215 is carrying out cleaning is an example case in which the status of the cleaner robot 21 is busy.

Other examples of the busy status encompass a case where the cleaner robot 21 is moving and a case where the resident of Room 101 is making any of settings to the cleaner robot 21.

Step S220: The control section 212 transmits (i) a busy notice indicating a state of being busy and (ii) its apparatus number “D7001” to the apparatus control server 10 via the communication section 211.

Step S222: The communication section 101 supplies, to the control section 102, the busy notice which has been received from the cleaner robot 21. The announcement managing section 111 of the control section 102 notifies the status judging section 114 that the busy notice has been received. When the busy notice has been received, the status judging section 114 determines that the apparatus (cleaner robot 21) whose apparatus number is “D7001” and which has transmitted the busy notice is in a status of “busy”. The status judging section 114 then supplies, to the announcement managing section 111, a judgment result indicating that the status of the apparatus number “D7001” is “busy”.

Step S224: The announcement managing section 111 obtains the status “busy” of the apparatus number “D7001”. When the announcement managing section 111 has obtained the status “busy” of the apparatus number “D7001”, the announcement managing section 111 waits to transmit a speaking content to the cleaner robot 21 whose apparatus number is “D7001”.

Step S226: When the cleaning being carried out by the cleaning section 215 is ended, the notification apparatus status judging section 231 determines that the status of the cleaner robot 21 has become not busy.

Step S228: The control section 212 transmits a busy canceled notice indicating a state of not being busy and its apparatus number “D7001” to the apparatus control server 10 via the communication section 211.

Step S230: The communication section 101 supplies, to the control section 102, the busy canceled notice which has been received from the cleaner robot 21. The announcement managing section 111 of the control section 102 notifies the status judging section 114 that the busy canceled notice has been received. The status judging section 114, which has received the busy canceled notice, determines that the status of the apparatus (cleaner robot 21) whose apparatus number is “D7001” and which has transmitted the busy canceled notice is “not busy”. The status judging section 114 then supplies, to the announcement managing section 111, a judgment result indicating that the status of the apparatus number “D7001” is “not busy”.

Step S232: Upon receipt of the judgment result “not busy” from the status judging section 114, the announcement managing section 111 instructs the audio data generating section 117 to generate audio speaking data that indicates a speaking content 1 “Ping Pong Pang Pong” and a speaking content 2 “Electric work will be carried out tomorrow” which are contained in registration information of the schedule supplied from the schedule managing section 115. In response to the instruction, the audio data generating section 117 generates speaking audio data “Ping Pong Pang Pong, electric work will be carried out tomorrow”, and supplies the speaking audio data to the announcement managing section 111.

Step S234: The announcement managing section 111 transmits (i) speaking audio data “Ping Pong Pang Pong, electric work will be carried out tomorrow” obtained from the audio data generating section 117 and (ii) a control signal for speaking (reproducing) the speaking audio data, to the cleaner robot 21 whose apparatus number is “D7001” via the communication section 101.

Step S236: The communication section 211 of the cleaner robot 21 supplies, to the control section 212, (i) the speaking audio data and (ii) the control signal for speaking the speaking audio data which have been received from the apparatus control server 10. Upon receipt of (i) the speaking audio data and (ii) the control signal for speaking the speaking audio data, the control section 212 reproduces the speaking audio data so that the speaker 213 speaks “Ping Pong Pang Pong, electric work will be carried out tomorrow”.

[Difference from Embodiment 1]

It has been described in Embodiment 1 that, in a case where the status of the apparatus number “D7001” is “busy”, the announcement managing section 111 waits, for the predetermined time period, to transmit a speaking content (registration information) to the cleaner robot 21 whose apparatus number is “D7001”. On the other hand, the announcement managing section 111 of Embodiment 2 waits to transmit a speaking content to the cleaner robot 21 until the announcement managing section 111 receives the busy canceled notice which indicates a state of being not busy from the cleaner robot 21.

In the present embodiment, the announcement managing section 111 does not obtain a reason why the cleaner robot 21 is in the status of busy. Under the circumstances, even if a waiting time is set for which the announcement managing section 111 waits to transmit a speaking content, the status of the cleaner robot 21 can be still busy even after the waiting time has elapsed. In order to avoid transmission/reception of unnecessary data, the announcement managing section 111 is configured to end the state of waiting for transmission of speaking information and then to transmit the speaking information to the cleaner robot 21 whose apparatus number is “D7001”, upon receipt of the busy canceled notice from the cleaner robot 21.

### Embodiment 3

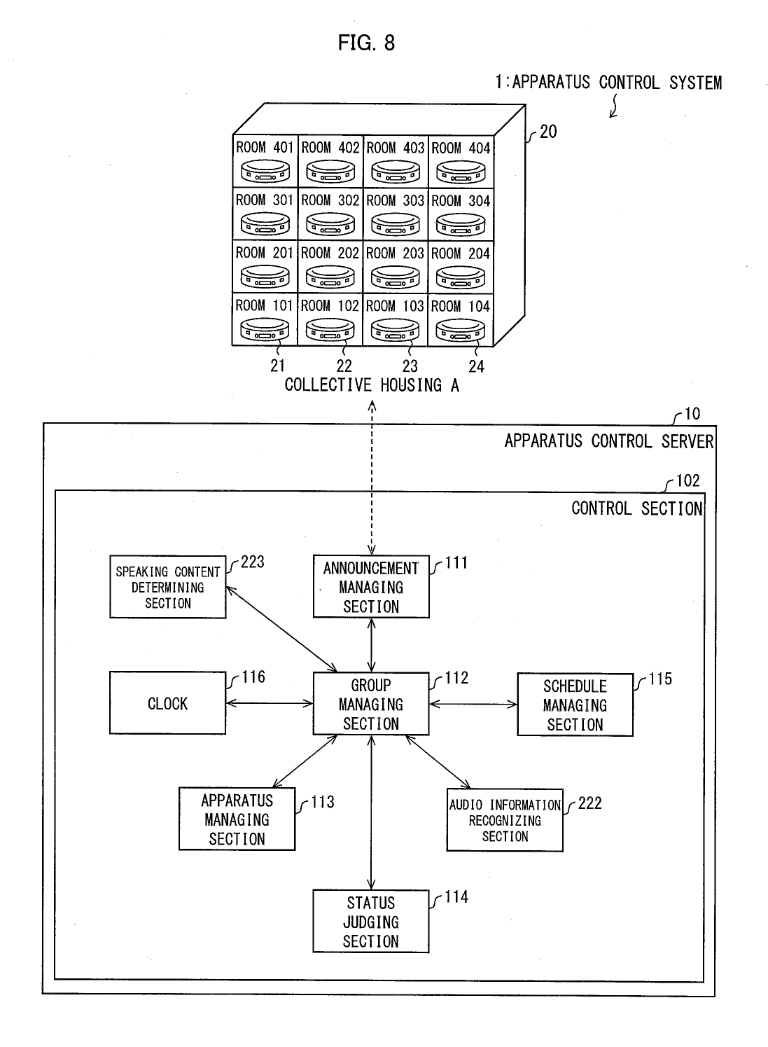

The following description will discuss another embodiment of the present invention with reference to FIG. 8 and FIGS. 10 and 11. For convenience, the same reference numerals are given to constituent members which have functions identical with those described in the above described embodiments, and descriptions regarding such constituent members are omitted.

FIG. 8 is a functional block diagram illustrating a configuration of the apparatus control server 10 in accordance with the present embodiment. As compared with the apparatus control server 10 of Embodiment 1, the apparatus control server 10 of the present embodiment further includes an audio information recognizing section 222 and a speaking content determining section 223.

According to the present embodiment, the obtaining section 217 of the cleaner robot 21 obtains a questioning audio from the user via the microphone 218 as questioning audio data, and supplies the questioning audio data to the control section 212.

The control section 212 of the cleaner robot 21 has the audio data transmitting section 233 which transmits the questioning audio data to the apparatus control server 10 via the communication section 211.

The control section 102 of the apparatus control server receives, via the communication section 101, the questioning audio data which has been transmitted by the cleaner robot 21. The announcement managing section 111 of the control section 102 transmits, to the audio information recognizing section 222, the questioning audio data and an instruction on recognizing audio information indicated by the questioning audio data.

The audio information recognizing section 222 is a control block for (i) recognizing audio information indicated by the questioning audio data and (ii) converting the audio information into a character string. When the audio information recognizing section 222 has recognized audio information indicated by the questioning audio data and converted the audio information into a character string, the audio information recognizing section 222 judges, with reference to a database stored in a storage section (not illustrated), whether or not the character string thus converted falls under any of recognition phrases (recognition character strings) which have been registered in the database in advance (character string judging step). As such, the audio information recognizing section 222 serves as a character string judging section. In a case where the character string falls under any of the recognition phrases, the audio information recognizing section 222 supplies the recognition phrase to the speaking content determining section 223.

The speaking content determining section 223 (answer character string determining section) determines, with reference to the database, an answer phrase (answer character string) which is associated with the obtained recognition phrase (answer character string determining step), and transmits the answer phrase to the announcement managing section 111.

The announcement managing section 111 determines the answer phrase, which has been obtained from the speaking content determining section 223, as notification information indicative of a content of a notification operation. Further, the announcement managing section 111 designates the cleaner robot 21, which has transmitted the questioning audio data, as the notification apparatus to carry out the notification operation. The announcement managing section 111 transmits, to the cleaner robot 21, an answer phrase which is notification information and an instruction on speaking the notification information.

The control section 212 of the cleaner robot 21 receives, via the communication section 211, (i) the answer phrase which is notification information and (ii) the instruction on speaking the notification information. The control section 212 controls the audio data generating section 235 to generate audio speaking data that indicates the answer phrase. The control section 212 reproduces the audio speaking data, which has been generated by the audio data generating section 235 and indicates the answer phrase, so that the answer phrase is outputted through the speaker 213.

According to the configuration, the apparatus control server 10, which has received the questioning audio data from the cleaner robot, can uniquely determine a destination of the answer phrase with respect to the questioning audio data.

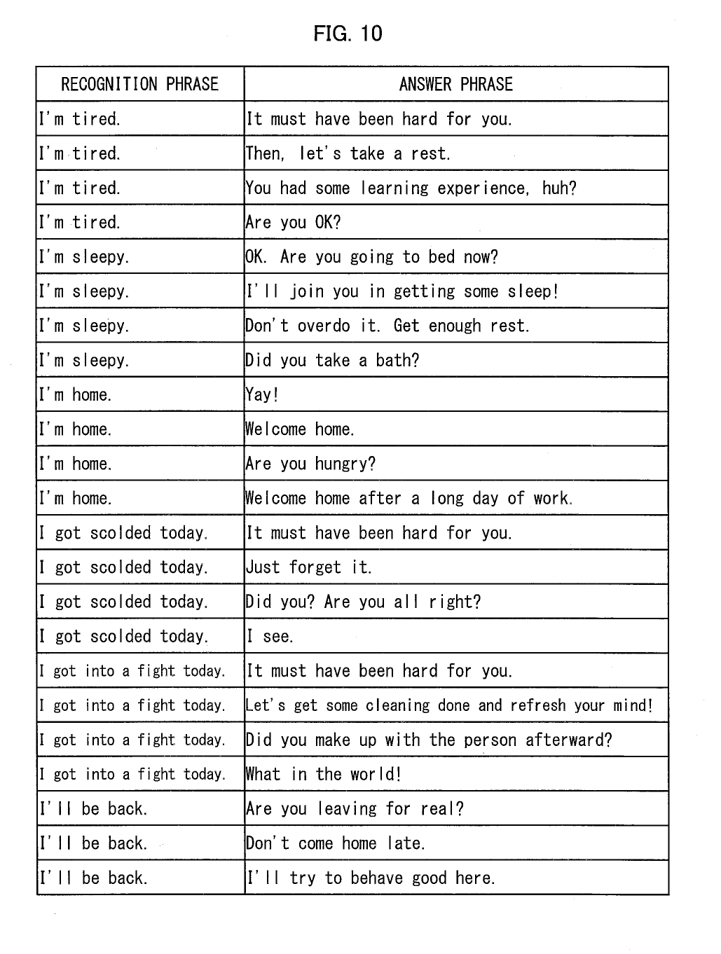

FIG. 10 is an example of recognition phrases and answer phrases registered in the database. A particular recognition phrase can be associated with one (1) answer phrase or a plurality of answer phrases. In a case where the particular recognition phrase is associated with one (1) answer phrase the speaking content determining section 223 selects the one answer phrase. Meanwhile, in a case where the particular recognition phrase is associated with a plurality of answer phrases, the speaking content determining section 223 can select any one of the plurality of answer phrases or can select and combine some of the plurality of answer phrases.

For example, in FIG. 10, a plurality of answer phrases are associated with a recognition phrase “I'm tired”. Out of associated answer phrases, the speaking content determining section 223 can select “Then, let's take a rest” or can select and combine “It must have been hard for you” and “Are you OK?”.

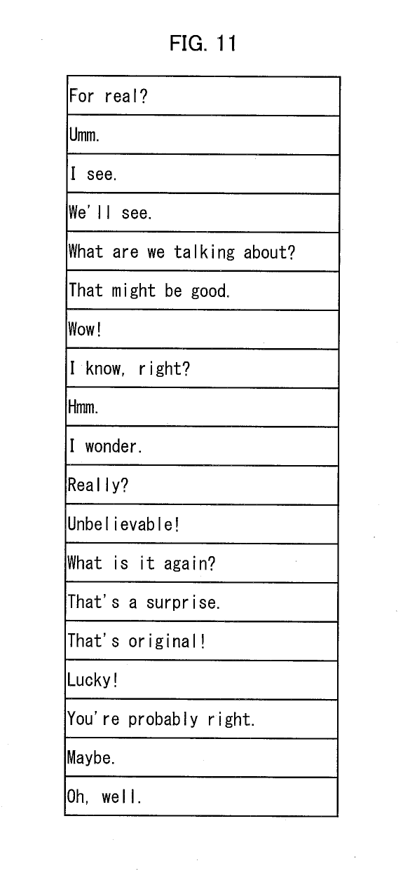

Note that, in a case where the audio information recognizing section 222 could not have recognized audio information indicated by the questioning audio data, the speaking content determining section 223 can select at least one of ambiguous phrases in an ambiguous database illustrated in FIG. 11 and transmit, to the announcement managing section 111, the selected ambiguous phrase as notification information. FIG. 11 is an example of ambiguous phrases stored in an ambiguous database. Alternatively, in a case where the audio information recognizing section 222 has recognized audio information indicated by the questioning audio data but a character string thus recognized is not any of recognition phrases (recognition character strings) registered in the database, the speaking content determining section 223 can selects at least one of the ambiguous phrases in the ambiguous database and transmit the selected ambiguous phrase to the announcement managing section 111 as notification information.

In these cases, the announcement managing section 111 determines the ambiguous phrase as the notification information that represents a content of a notification operation. Note that the ambiguous database in which the ambiguous phrases are stored is separated from the database illustrated in FIG. 10. Alternatively, in a case where the announcement managing section 111 selects an ambiguous phrase from the ambiguous database, the announcement managing section 111 can select the ambiguous phrase under a predetermined condition (e.g., select phrases in the ambiguous database from top to bottom) or can randomly select an ambiguous phrase. When the configuration in which an ambiguous phrase is randomly selected is employed, it is possible to give the user the impression of more natural communication.

### Embodiment 4

The following description will discuss another embodiment of the present invention. For convenience, the same reference numerals are given to constituent members which have functions identical with those described in the above described embodiments, and descriptions regarding such constituent members are omitted.

Although not illustrated in FIG. 6, each of schedules in the schedule managing table can be given an already-transmitted flag. The already-transmitted flag indicates whether or not a corresponding schedule has already been transmitted to the notification apparatus. In a case where the corresponding schedule has already been transmitted to the notification apparatus, a value of the already-transmitted flag is “1”. On the other hand, in a case where the corresponding schedule has not been transmitted to the notification apparatus yet, a value of the already-transmitted flag is “0”. According to the present embodiment, giving the already-transmitted flag means that the value of the already-transmitted flag is set to “1”. Moreover, cancellation of the already-transmitted flag means that the value of the already-transmitted flag is set to “0”.

It is preferable that the schedule managing section 115 manages notification information, to which the already-transmitted flag has been given, as information that is not to be transmitted to the notification apparatus. According to the configuration, it is possible to prevent the apparatus control server 10 from repeatedly notifying a notification content which has been once notified already.

The schedule managing section 115 can be configured to cancel the already-transmitted flag when a predetermined time period has elapsed from when the already-transmitted flag was given.

### Embodiment 5

The control blocks of the apparatus control server 10 and the cleaner robot 21 (in particular, the announcement managing section 111, the status judging section 114, the schedule managing section 115, the notification apparatus status judging section 231, and the status transmitting section 232) may be realized by a logic circuit (hardware) provided in an integrated circuit (IC chip) or the like or may be realized by software as executed by a CPU (Central Processing Unit).

In the latter case, the apparatus control server 10 and the cleaner robot 21 include: a CPU that executes instructions of a program that is software realizing the foregoing functions; ROM (Read Only Memory) or a storage device (each referred to as “storage medium”) storing the program and various kinds of data in such a form that they are readable by a computer (or a CPU); and RAM (Random Access Memory) into which the program is loaded in executable form. The object of the present invention can be achieved by a computer (or a CPU) reading and executing the program stored in the storage medium. The storage medium may be “a non-transitory tangible medium” such as a tape, a disk, a card, a semiconductor memory, and a programmable logic circuit. Further, the program may be supplied to or made available to the computer via any transmission medium (such as a communication network and a broadcast wave) which enables transmission of the program. Note that the present invention can also be implemented by the program in the form of a computer data signal embedded in a carrier wave which is embodied by electronic transmission.

[Main Points]

The apparatus control method in accordance with an aspect 1 of the present invention includes the steps of: (a) designating at least one notification apparatus to carry out a notification operation; (b) determining notification information that indicates a content of the notification operation; (c) judging a status of a designated notification apparatus which has been designated in the step (a); and (d) transmitting the notification information to the designated notification apparatus in accordance with a judgment result obtained in the step (c).

The apparatus control method in accordance with an aspect 2 of the present invention preferably further includes, in the aspect 1, the step of (e) managing correspondence information in which each notification apparatus is associated with notification information indicating a content of at least one notification operation, the notification apparatus to carry out the notification operation being designated in the step (a) with reference to the correspondence information, and the notification information that indicates the content of the at least one notification operation being determined in the step (b) with reference to the correspondence information.

According to the apparatus control method in accordance with an aspect 3 of the present invention, it is preferable in the aspect 2 that, in the step (e), notification information, which indicates a content of at least one notification operation, is collectively registered with respect to pieces of correspondence information of respective of a plurality of notification apparatuses.

According to the apparatus control method in accordance with an aspect 4 of the present invention, it is preferable in the aspect 2 or 3 that, in the step (e), a notification time at which a notification operation is carried out is managed.

According to the apparatus control method in accordance with an aspect 5 of the present invention, it is possible in any one of the aspects 1 through 4 that the apparatus control method further includes the steps of: (f) judging whether or not communication with the designated notification apparatus is available, in a case where it has been determined in the step (f) that the communication is unavailable, a status of the designated notification apparatus being determined to be busy in the step (c).

According to the apparatus control method in accordance with an aspect 6 of the present invention, it is possible in the aspect 5 that, in the step (f), it is further judged whether or not the designated notification apparatus is ready to receive the notification information; and in a case where it has been determined in the step (f) that the designated notification apparatus is not ready to receive the notification information, it is determined in the step (c) that the status of the designated notification apparatus is busy.

According to the apparatus control method in accordance with an aspect 7 of the present invention, it is possible in any one of the aspects 1 through 6 that the apparatus control method further includes the step of: (g) obtaining, from the designated notification apparatus, a notification apparatus status which is a status of the designated notification apparatus, in a case where a notification unable notice, which indicates that the designated notification apparatus is not ready to carry out notification, has been obtained in the step (g) as the notification apparatus status, a status of the designated notification apparatus being determined to be busy in the step (c).

According to the apparatus control method in accordance with an aspect 8 of the present invention, it is possible in the aspect 7 that, in a case where a notification inappropriate notice, which indicates that notification should not be carried out, is obtained in the step (g) as the notification apparatus status, it is determined in the step (c) that a status of the designated notification apparatus is busy.

According to the apparatus control method in accordance with an aspect 9 of the present invention, it is preferable in any one of the aspects 1 through 8 that, in the step (d), in a case where the notification information is being transmitted to the designated notification apparatus or a predetermined time period has not elapsed from when the notification information was transmitted, it is determined in the step (c) that a status of the designated notification apparatus is busy.

According to the apparatus control method in accordance with an aspect 10 of the present invention, it is preferable in any one of the aspects 1 through 9 that, in the step (d), in a case where notification information, which was determined in the step (b), has been transmitted to the designated notification apparatus and then a notice indicative of being busy has been received from the designated notification apparatus, it is determined in the step (c) that a status of the designated notification apparatus is busy.

According to the apparatus control method in accordance with an aspect 11 of the present invention, it is preferable in any one of the aspects 1 through 10 that, in a case where it has been determined in the step (c) that the status of the designated notification apparatus is busy, transmission of the notification information to the designated notification apparatus is waited in the step (d).

According to the apparatus control method in accordance with an aspect 12 of the present invention, it is preferable in any one of the aspects 1 through 11 that, in a case where it has been determined in the step (c) that the status of the designated notification apparatus is busy and then, from the designated notification apparatus, a notice has been received which indicates that the designated notification apparatus is no longer busy, the notification information is transmitted to the designated notification apparatus in the step (d).

According to the apparatus control method in accordance with an aspect 13 of the present invention, it is preferable in the aspect 4 that, in a case where it has been determined in the step (c) that the status of the designated notification apparatus is busy, the notification time is reset to be delayed by a predetermined time period in the step (e).

According to the apparatus control method in accordance with an aspect 14 of the present invention, it is preferable in any one of the aspects 2 through 13 that, in the step (e), notification information, which has been transmitted to a notification apparatus to carry out a notification operation, is given an already-transmitted flag which represents that the notification information has already been transmitted, and the notification information, to which the already-transmitted flag has been given, is managed as information which is not to be transmitted to the notification apparatus.

According to the apparatus control method in accordance with an aspect 15 of the present invention, it is preferable in the aspect 14 that, in the step (e), the already-transmitted flag is canceled when a predetermined time period has elapsed from when the already-transmitted flag was given.

According to the apparatus control method in accordance with an aspect 16 of the present invention, it is preferable in any one of the aspects 1 through 15 that the apparatus control method further includes the steps of: (h) judging, upon receipt of audio data from a notification apparatus, whether or not a character string indicated by the audio data is any of recognition character strings which have been registered in advance; and (i) determining an answer character string which is associated with the character string that is indicated by the audio data and has been determined to be any of the recognition character strings registered in advance, the answer character string, which has been determined in the step (i), being determined in the step (b) as the notification information that indicates the content of the notification operation.

According to the apparatus control method in accordance with an aspect 17 of the present invention, it is preferable in the aspect 16 that a plurality of answer character strings are associated with one (1) recognition character string; and in the step (i), at least one of the plurality of answer character strings associated with the one recognition character string is selected as the answer character string.

The apparatus control server (10) in accordance with an aspect 18 of the present invention includes: a notification apparatus designating section (schedule managing section 115) configured to designate at least one notification apparatus to carry out a notification operation; a notification information determining section (schedule managing section 115) configured to determine notification information that indicates a content of the notification operation; a status judging section (114) configured to judge a status of a designated notification apparatus which has been designated by the notification apparatus designating section; and a transmitting section (announcement managing section 111) configured to transmit the notification information to the designated notification apparatus in accordance with a judgment result obtained by the status judging section.

The notification apparatus in accordance with an aspect 19 of the present invention is a notification apparatus which receives notification information transmitted from an apparatus control server, carries out a content of a notification operation indicated by the notification information, and includes: a notification apparatus status judging section (notification apparatus status judging section 231) configured to judge whether or not a status of the notification apparatus is busy; and a status transmitting section (status transmitting section 232) configured to transmit a notice which indicates that the status of the notification apparatus is busy in a case where the notification apparatus status judging section has determined that the status of the notification apparatus is busy.

According to the notification apparatus in accordance with an aspect 20 of the present invention, it is preferable in the aspect 19 that the notification apparatus is a cleaner robot which further includes a moving section for moving and a cleaning section for cleaning.

According to the notification apparatus in accordance with an aspect 21 of the present invention, it is preferable in the aspect 20 that, in a case where the moving section is carrying out moving, the notification apparatus status judging section determines that the status of the notification apparatus is busy.

According to the notification apparatus in accordance with an aspect 22 of the present invention, it is preferable in the aspect 20 or 21 that, in a case where the cleaning section is carrying out cleaning, the notification apparatus status judging section determines that the status of the notification apparatus is busy.

According to the notification apparatus in accordance with an aspect 23 of the present invention, it is preferable in any one of the aspects 19 through 22 that, when the status determined by the notification apparatus status judging section is changed from busy to not busy, the status transmitting section transmits a notice which indicates that the notification apparatus is no longer busy.

The robot terminal in accordance with an aspect 24 of the present invention includes: a questioning audio obtaining section (microphone 218 and obtaining section 217) configured to obtain an audio given by a user as questioning audio data; an audio data transmitting section (audio data transmitting section 233) configured to transmit the questioning audio data; a notification information receiving section (notification information receiving section 234) configured to receive notification information that contains an answer character string associated with audio information indicated by the questioning audio data; an audio data generating section (audio data generating section 235) configured to generate audio speaking data that represents the answer character string; and an audio data outputting section (speaker 213) configured to output the audio speaking data by reproducing the audio speaking data.

The apparatus control system in accordance with an aspect 25 of the present invention includes an apparatus control server and a notification apparatus,

the notification apparatus includes: a notification apparatus status judging section configured to judge whether or not a status of the notification apparatus is busy; and a transmitting section configured to transmit a notice which indicates that the status of the notification apparatus is busy in a case where the notification apparatus status judging section has determined that the status of the notification apparatus is busy,

the apparatus control server includes: a notification apparatus designating section configured to designate at least one notification apparatus to carry out a notification operation; a notification information determining section configured to determine notification information that indicates a content of the notification operation; a status judging section configured to judge whether or not a status of a designated notification apparatus, which has been designated by the notification apparatus designating section, is busy; and a transmitting section configured to transmit the notification information to the designated notification apparatus in a case where the status determined by the status judging section is not busy, upon receipt of a notice which indicates the status of busy and has been transmitted from the designated notification apparatus, the status judging section determining that the status of the designated notification apparatus is busy.

Each of the apparatus control server and the notification apparatus in accordance with each of the aspects of the present invention can be realized by a computer. In such a case, the present invention encompasses (i) a program of the apparatus control server which program causes the computer to serve as the above described sections for realizing the apparatus control server or the notification apparatus and (ii) a computer-readable storage medium storing the program.

The present invention is not limited to the embodiments, but can be altered by a skilled person in the art within the scope of the claims. An embodiment derived from a proper combination of technical means disclosed in respective different embodiments is also encompassed in the technical scope of the present invention. Further, it is possible to form a new technical feature by combining the technical means disclosed in the respective embodiments.

### INDUSTRIAL APPLICABILITY

The present invention is applicable to an apparatus control server, an apparatus control method, a notification apparatus, a robot terminal, an apparatus control system, and a program.

### REFERENCE SIGNS LIST

1: Apparatus control system
10: Server (apparatus control server)
101: Communication section
102: Control section
103: Main storage device
104: Auxiliary storage device
111: Announcement managing section (transmitting section)
114: Status judging section (status judging section)
115: Schedule managing section (notification apparatus designating section)
21: Cleaner robot
211: Communication section
212: Control section
213: Speaker
214: Display section
215: Cleaning section
216: Driving section
217: Obtaining section
218: Microphone
219: Operation section
231: Notification apparatus status judging section (notification apparatus status judging section)
232: Status transmitting section (status transmitting section)
233: Audio data transmitting section (audio data transmitting section)
234: Notification information receiving section (notification information receiving section)
235: Audio data generating section (audio data generating section)
A: Collective housing

1. A method for controlling an apparatus, said method comprising the steps of:
(a) designating at least one notification apparatus to carry out a notification operation;
(b) determining notification information that indicates a content of the notification operation;
(c) judging a status of a designated notification apparatus which has been designated in the step (a); and
(d) transmitting the notification information to the designated notification apparatus in accordance with a judgment result obtained in the step (c).

2. The method as set forth in claim 1, further comprising the step of:
(e) managing correspondence information in which each notification apparatus is associated with notification information indicating a content of at least one notification operation,
the notification apparatus to carry out the notification operation being designated in the step (a) with reference to the correspondence information, and
the notification information that indicates the content of the at least one notification operation being determined in the step (b) with reference to the correspondence information.

3. The method as set forth in claim 2, wherein:
in the step (e), notification information, which indicates a content of at least one notification operation, is collectively registered with respect to pieces of correspondence information of respective of a plurality of notification apparatuses.

4. The method as set forth in claim 2, wherein:
in the step (e), a notification time at which a notification operation is carried out is managed.

5. The method as set forth in claim 1, further comprising the step of:
(f) judging whether or not communication with the designated notification apparatus is available,
in a case where it has been determined in the step (f) that the communication is unavailable, a status of the designated notification apparatus being determined to be busy in the step (c).

6. The method as set forth in claim 5, wherein:
in the step (f), it is further judged whether or not the designated notification apparatus is ready to receive the notification information; and
in a case where it has been determined in the step (f) that the designated notification apparatus is not ready to receive the notification information, it is determined in the step (c) that the status of the designated notification apparatus is busy.

7. The method as set forth in claim 1, further comprising the step of:
(g) obtaining, from the designated notification apparatus, a notification apparatus status which is a status of the designated notification apparatus,
in a case where a notification unable notice, which indicates that the designated notification apparatus is not ready to carry out notification, has been obtained in the step (g) as the notification apparatus status, a status of the designated notification apparatus being determined to be busy in the step (c).

8. The method as set forth in claim 7, wherein:
in a case where a notification inappropriate notice, which indicates that notification should not be carried out, is obtained in the step (g) as the notification apparatus status, it is determined in the step (c) that a status of the designated notification apparatus is busy.

9. The method as set forth in claim 1, wherein:
in the step (d), in a case where the notification information is being transmitted to the designated notification apparatus or a predetermined time period has not elapsed from when the notification information was transmitted, it is determined in the step (c) that a status of the designated notification apparatus is busy.

10. The method as set forth in claim 1, wherein:
in the step (d), in a case where notification information, which was determined in the step (b), has been transmitted to the designated notification apparatus and then a notice indicative of being busy has been received from the designated notification apparatus, it is determined in the step (c) that a status of the designated notification apparatus is busy.

11. The method as set forth in claim 1, wherein:
in a case where it has been determined in the step (c) that the status of the designated notification apparatus is busy, transmission of the notification information to the designated notification apparatus is waited in the step (d).

12. The method as set forth in claim 1, wherein:
in a case where it has been determined in the step (c) that the status of the designated notification apparatus is busy and then, from the designated notification apparatus, a notice has been received which indicates that the designated notification apparatus is no longer busy, the notification information is transmitted to the designated notification apparatus in the step (d).

13. The method as set forth in claim 4, wherein:
in a case where it has been determined in the step (c) that the status of the designated notification apparatus is busy, the notification time is reset to be delayed by a predetermined time period in the step (e).

14. The method as set forth in claim 2, wherein:
in the step (e), notification information, which has been transmitted to a notification apparatus to carry out a notification operation, is given an already-transmitted flag which represents that the notification information has already been transmitted, and the notification information, to which the already-transmitted flag has been given, is managed as information which is not to be transmitted to the notification apparatus.

15. The method as set forth in claim 14, wherein:
in the step (e), the already-transmitted flag is canceled when a predetermined time period has elapsed from when the already-transmitted flag was given.

16. The method as set forth in claim 1, further comprising the steps of:
(h) judging, upon receipt of audio data from a notification apparatus, whether or not a character string indicated by the audio data is any of recognition character strings which have been registered in advance; and
(i) determining an answer character string which is associated with the character string that is indicated by the audio data and has been determined to be any of the recognition character strings registered in advance,
the answer character string, which has been determined in the step (i), being determined in the step (b) as the notification information that indicates the content of the notification operation.

17. The method as set forth in claim 16, wherein:
a plurality of answer character strings are associated with one (1) recognition character string; and
in the step (i), at least one of the plurality of answer character strings associated with the one recognition character string is selected as the answer character string.

18. An apparatus control server comprising:
a notification apparatus designating section configured to designate at least one notification apparatus to carry out a notification operation;
a notification information determining section configured to determine notification information that indicates a content of the notification operation;
a status judging section configured to judge a status of a designated notification apparatus which has been designated by the notification apparatus designating section; and
a transmitting section configured to transmit the notification information to the designated notification apparatus in accordance with a judgment result obtained by the status judging section.

19. A notification apparatus which receives notification information transmitted from an apparatus control server and carries out a content of a notification operation indicated by the notification information, said notification apparatus comprising:
a notification apparatus status judging section configured to judge whether or not a status of said notification apparatus is busy; and
a status transmitting section configured to transmit a notice which indicates that the status of said notification apparatus is busy, in a case where the notification apparatus status judging section has determined that the status of said notification apparatus is busy.

20. The notification apparatus as set forth in claim 19, wherein:
said notification apparatus is a cleaner robot which further includes a moving section for moving and a cleaning section for cleaning.

21. The notification apparatus as set forth in claim 20, wherein:
in a case where the moving section is carrying out moving, the notification apparatus status judging section determines that the status of said notification apparatus is busy.

22. The notification apparatus as set forth in claim 20, wherein:
in a case where the cleaning section is carrying out cleaning, the notification apparatus status judging section determines that the status of said notification apparatus is busy.

23. The notification apparatus as set forth in claim 19, wherein:
when the status determined by the notification apparatus status judging section is changed from busy to not busy, the status transmitting section transmits a notice which indicates that said notification apparatus is no longer busy.

24. A robot terminal comprising:
a questioning audio obtaining section configured to obtain an audio given by a user as questioning audio data;
an audio data transmitting section configured to transmit the questioning audio data;
a notification information receiving section configured to receive notification information that contains an answer character string associated with audio information indicated by the questioning audio data;
an audio data generating section configured to generate audio speaking data that represents the answer character string; and
an audio data outputting section configured to output the audio speaking data by reproducing the audio speaking data.

25. An apparatus control system comprising an apparatus control server and a notification apparatus,
the notification apparatus including:
a notification apparatus status judging section configured to judge whether or not a status of the notification apparatus is busy; and
a transmitting section configured to transmit a notice which indicates that the status of the notification apparatus is busy in a case where the notification apparatus status judging section has determined that the status of the notification apparatus is busy,
the apparatus control server including:
a notification apparatus designating section configured to designate at least one notification apparatus to carry out a notification operation;
a notification information determining section configured to determine notification information that indicates a content of the notification operation;
a status judging section configured to judge whether or not a status of a designated notification apparatus, which has been designated by the notification apparatus designating section, is busy; and
a transmitting section configured to transmit the notification information to the designated notification apparatus in a case where the status determined by the status judging section is not busy,
upon receipt of a notice which indicates the status of busy and has been transmitted from the designated notification apparatus, the status judging section determining that the status of the designated notification apparatus is busy.

26. A non-transitory computer-readable storage medium in which a program for causing a computer to serve as an apparatus control server recited in claim 18, the program causing the computer to serve as each of the sections of the apparatus control server.

27. A non-transitory computer-readable storage medium in which a program for causing a computer to serve as a notification apparatus recited in claim 19, the program causing the computer to serve as each of the sections of the notification apparatus.
